(19) United States
(12) Patent Application Publication
(10) Pub. No.: US 2026/0348329 A1
(43) Pub. Date: Nov. 5, 2026

(54) GAS TURBINE ENGINE HAVING COMPOSITE FAN BLADES

(71) Applicant: General Electric Company, Evendale, OH (US)

(72) Inventors: Arthur William Sibbach, Boxford, MA (US); Gary Willard Bryant, Jr., Loveland, OH (US)

(21) Appl. No.: 19/745,168

(22) Filed: Jul. 17, 2026

Related U.S. Application Data
(63) Continuation-in-part of application No. 19/362,542, filed on Oct. 20, 2025.
Application No. 19/362,542 is a continuation of application No. 18/909,259, filed on Oct. 8, 2024, now Pat. No. 12,473,863.
Application No. 18/909,259 is a continuation-in-part of application No. 18/603,773, filed on Mar. 13, 2024, now Pat. No. 12,473,832.

(51) Int. Cl. F02C 7/36

(52) U.S. Cl. CPC F02C 7/36; F05D 2220/36; F05D 2260/4031

(57) ABSTRACT

A gas turbine engine includes: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio during operation of the gas turbine engine in a cruise operating mode; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8.

### CROSS-REFERENCE TO RELATED APPLICATIONS

This application is a continuation-in-part application of U.S. application Ser. No. 19/362,542, filed Oct. 20, 2025, which is a continuation of U.S. application Ser. No. 18/909,259 filed Oct. 8, 2024, which is a continuation-in-part application of U.S. application Ser. No. 18/603,773 filed Mar. 13, 2024, which is a non-provisional application. Each of the aforementioned applications is incorporated by reference herein in its entirety, and is hereby expressly made a part of this specification.

### FIELD

The present disclosure relates to a gas turbine engine having composite fan blades.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extract energy from the combustion gases for powering the compressor(s), as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a close-up view of a blade of the gas turbine engine of FIG. 1 in accordance with an exemplary aspect of the present disclosure.

FIG. 3 is a table of example engines of the present disclosure.

FIG. 4 is a cross-sectional view of a gas turbine engine in accordance with another exemplary aspect of the present disclosure

FIG. 5 is a schematic cross-sectional view of an exemplary gas turbine engine according to various embodiments of the present subject matter.

FIG. 6 is a perspective view of an exemplary gas turbine engine according to another exemplary embodiment of the present disclosure having a thrust reverser system in a fully deployed position.

FIG. 7 is an axial, side, sectional view of the exemplary gas turbine engine of FIG. 6 depicting the thrust reverser system in a fully stowed position and in a fully deployed position in the upper and lower halves of the view, respectively.

FIG. 8 is a close-up, sectional view of a section of the exemplary thrust reverser system in a fully stowed position and a fully deployed position (in phantom).

FIG. 9 is an axial, side, sectional view of the exemplary gas turbine engine of FIG. 6 depicting the thrust reverser system in a partially deployed position.

FIG. 10 provides a schematic view of a locking mechanism in accordance with an exemplary embodiment of the present disclosure.

FIG. 11 provides a flow diagram of a method for operating a gas turbine engine in accordance with an exemplary aspect of the present disclosure.

FIG. 12A is an axial, side, sectional view of the exemplary gas turbine engine of FIG. 5 depicting the thrust reverser assembly in a position corresponding to a high-power flight phase of the gas turbine engine.

FIG. 12B is an axial, side, sectional view of the exemplary gas turbine engine of FIG. 5 depicting the thrust reverser assembly in a position corresponding to a cruise or low-power flight phase of the gas turbine engine.

FIG. 12C is an axial, side, sectional view of the exemplary gas turbine engine of FIG. 5 depicting the thrust reverser assembly in a deployed position.

FIG. 13A is a sectional view of a portion of the thrust reverser assembly positioned as depicted in FIG. 12A in accordance with the present disclosure.

FIG. 13B is a sectional view of a portion of the thrust reverser assembly positioned as depicted in FIG. 12B in accordance with the present disclosure.

FIG. 13C is a sectional view of a portion of the thrust reverser assembly deployed as depicted in FIG. 12C in accordance with the present disclosure.

FIG. 14 is a flow diagram depicting an embodiment of a method of varying a size of a fan nozzle of a gas turbine engine in accordance with various aspects of the present disclosure.

FIG. 15 is a block diagram depicting an example computing system according to exemplary embodiments of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The phrases “from X to Y” and “between X and Y” each refers to a range of values inclusive of the endpoints (i.e., refers to a range of values that includes both X and Y).

The term “turbomachine” refers to a machine including one or more compressors, a heat generating section (e.g., a combustion section), and one or more turbines that together generate a torque output.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The term “disk loading” refers to an average pressure change across a plurality of rotor blades of a rotor assembly, such as the average pressure change across a plurality of fan blades of a fan.

As used herein, the term “rated speed” with reference to a gas turbine engine refers to a maximum rated speed of the gas turbine engine. For example, in an engine certified by the Federal Aviation Administration (“FAA”), the rated speed refers to a rotation speed of the engine during the highest sustainable and continuous power operation in the certification documents, such as a rotational speed of the gas turbine engine when operating under a maximum continuous operation.

The term “cruise operating mode” (or “cruise condition”) refers to the condition of a gas turbine engine utilized to power an aircraft while operating at a cruise speed when the aircraft levels after climbing to a specified altitude associated with cruise flight. A gas turbine engine may operate at a cruise speed that is from 50% to 90% of a rated speed, such as from 70% to 80% of the rated speed. As used herein, the term “cruise flight” refers to a phase of flight in which an aircraft levels in altitude after a climb phase and prior to descending to an approach phase. In most flight envelopes, the cruise operating mode is exemplified by the operating mode of the gas turbine engine at a midpoint of the particular flight envelope based on a total fuel burn for the flight envelope (i.e., when the gas turbine engine has burned 50% of the total fuel burn for that gas turbine engine during the flight operation).

In various examples, cruise flight may take place at a cruise altitude up to approximately 65,000 feet (ft.). In certain examples, cruise altitude is between approximately 28,000 ft. and approximately 45,000 ft. In yet other examples, cruise altitude is expressed in flight levels (FL) based on a standard air pressure at sea level, in which cruise flight is between FL280 and FL650. In another example, cruise flight is between FL280 and FL450. In still certain examples, cruise altitude is defined based at least on a barometric pressure, in which cruise altitude is between approximately 4.85 psia and approximately 0.82 psia based on a sea-level pressure of approximately 14.70 psia and sea-level temperature at approximately 59 degrees Fahrenheit. In another example, cruise altitude is between approximately 4.85 psia and approximately 2.14 psia. It should be appreciated that, in certain examples, the ranges of cruise altitude defined by pressure may be adjusted based on a different reference sea-level pressure and/or sea-level temperature.

The term “thrust rating” for a gas turbine engine refers to a maximum amount of thrust the gas turbine engine can generate when operating at the rated speed during standard day operating conditions (i.e., sea level under standard temperature and pressure conditions).

As used herein, the term “fan pressure ratio” as it relates to a plurality of fan blades of a fan, refers to a ratio of an air pressure immediately downstream of the fan blades during operation of the fan to an air pressure immediately upstream of the fan blades of the fan during operation of the fan.

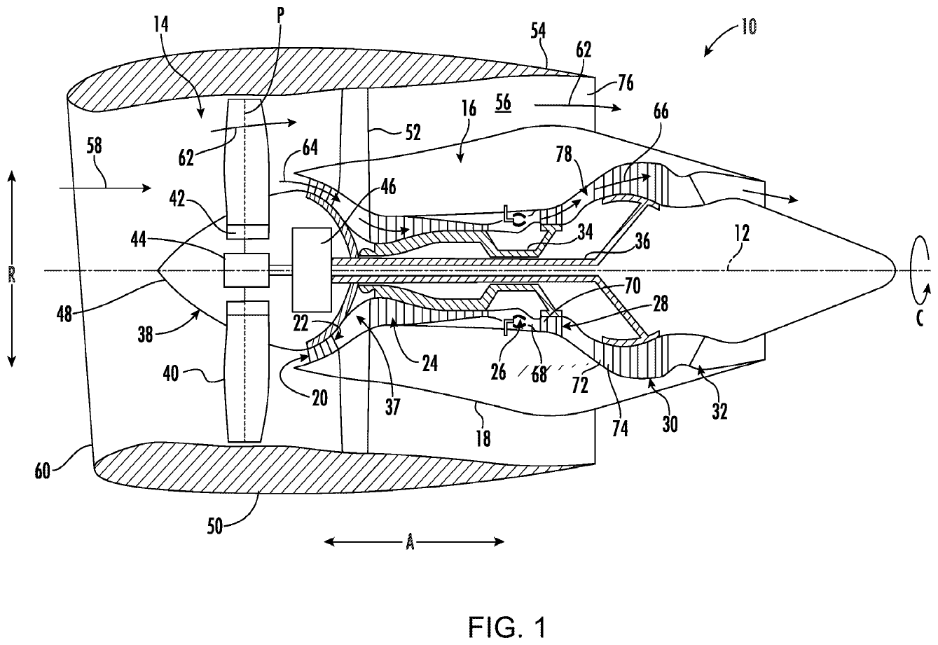

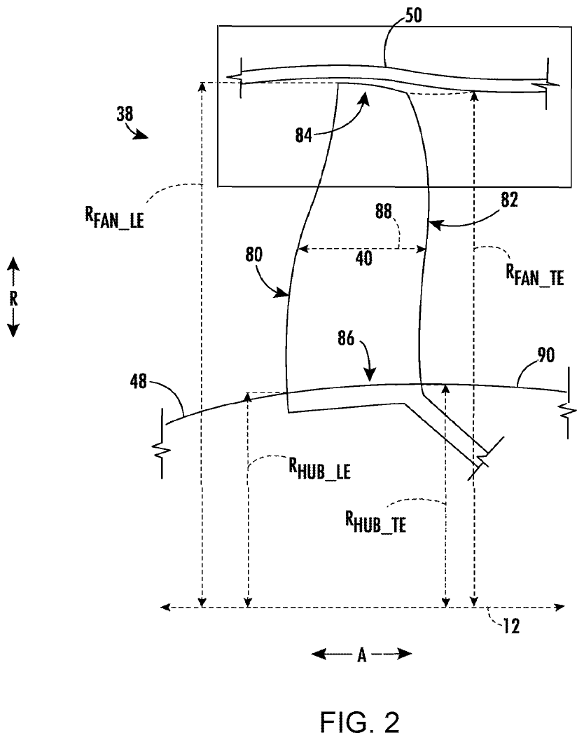

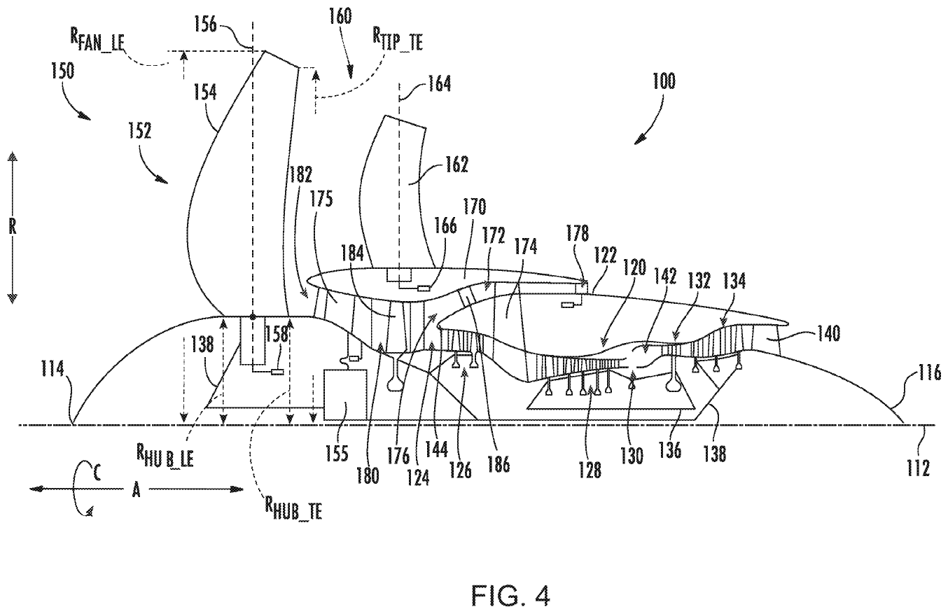

The term “bypass passage” refers generally to a passage with an airflow from a fan of the gas turbine engine that flows over an upstream-most ducted inlet to a turbomachine of the gas turbine engine. In a ducted gas turbine engine, the bypass passage is the passage defined between an outer nacelle (surrounding the fan of the gas turbine engine) and one or more cowls inward of the outer nacelle (e.g., a fan cowl, a core cowl or both if both are present; see, e.g., FIGS. 1 and 2). In an unducted gas turbine engine, the bypass passage refers to an open sided passage (i.e., not explicitly defined by structure such as an outer nacelle) where airflow from the fan passes over an upstream-most inlet to the turbomachine (e.g., inlet 182 to inlet duct 180 in FIG. 4), defined at least in part by a primary fan outer fan area, which refers to an area defined by an annulus representing a portion of the fan located outward of an inlet splitter at the upstream-most inlet to the turbomachine (e.g., inlet splitter of the fan cowl 170 in the embodiment of FIG. 4). An airflow through the bypass passage of a ducted or an unducted engine refers to all of the airflow from the fan that is not provided through the upstream-most inlet to the turbomachine.

The term “bypass ratio” refers to a ratio in a gas turbine engine of a mass flowrate of an airflow from a primary fan through a bypass passage to a mass flowrate of an airflow that passes through the engine's upstream-most ducted inlet. For example, in the embodiment of FIGS. 1, and 4 discussed below, the bypass ratio refers to a mass flowrate of an airflow through the bypass passage (e.g., from a fan 38, 152 that flows over an outer casing 18 or a fan cowl 170) to a mass flowrate of an airflow from the fan 38, 152 that flows through the engine inlet 20, 182. The bypass ratio may be defined during operation of the gas turbine engine in a cruise operating mode.

As used herein, the term “composite material” refers to a material produced from two or more constituent materials, wherein at least one of the constituent materials is a non-metallic material. A composite material is made by combining two or more distinct materials having a finite interface between them. The two or more distinct materials have different chemical and physical properties in relation to one another. One of the two or more distinct materials is the reinforcement (or reinforcing phase), while the other of the two or more distinct materials is the matrix phase. Example composite materials include polymer matrix composites (PMC), ceramic matrix composites (CMC), metal matrix composites (MMC) having a non-metallic reinforcement phase, chopped fiber composite materials, etc.

As used herein, polymer matrix composites or “PMC” refers to a class of materials that include a polymer resin matrix and fibers that are stronger than the matrix, stiffer than the matrix, or both. The fibers may be a variety of materials, nonlimiting examples of which include carbon (e.g., graphite) fibers, glass (e.g., fiberglass) fibers, polymer (e.g., Kevlar®) fibers, basalt fibers, ceramic fibers (e.g. silicon carbide or alumina) and metal fibers. Resins for PMC matrix materials can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific examples of high performance thermoplastic resins that have been contemplated for use in aerospace applications include polyetheretherketone (PEEK), polyetherketoneketone (PEKK), polyetherimide (PEI), and polyphenylene sulfide (PPS). In contrast, once fully cured into a hard rigid solid, thermoset resins do not undergo significant softening when heated but, instead, thermally decompose when sufficiently heated. Notable examples of thermoset resins include epoxy, bismaleimide (BMI), polyesters, vinylesters, phenolics, and polyimide resins.

PMC materials are produced in various forms for different types for manufacturing. PMC manufacturing may be generally classified into two types: (1) prepreg layup where the operators start with materials where the fibers are preimpregnated with resin usually in thin layers which may be placed in a mold and cured to form the part; and (2) infusion where dry fibers are assembled into a preform shape and resin is infused or injected into the dry preform. There are also many subvariants of these two approaches.

Prepregs may be unidirectional fibers impregnated with resin or fabrics with fibers in multiple directions (e.g., woven fabrics, braids, non-crimp fabrics, uniweave fabrics) impregnated with resin and are typically 0.002 inches (in) to 0.050 in thick. Prepregs may come in wide rolls where the manufacturer cuts ply shapes, stack the cut ply shapes into the mold and cure to the make the final shape. Prepregs may be slit into narrower widths (e.g., ⅛ in to 12 in) and applied to a mold using automated fiber placement (AFP), then cured to create a final geometry. Prepregs may also be slit and chopped into small chips (e.g., 1 in×2 in, ½ in×1 in, 1 in×1 in), dropped randomly into a mold and cured to make a part.

For infusion, the dry preform may be produced in various ways. Layers of dry woven fabric, braid, and/or non-crimp fabric may be stacked together into a shape. Fibers may be woven into a final shape using 3D weave to create the preform. The resin may also be introduced in various ways. The resin may be introduced via vacuum assisted transfer molding (VARTM) where the dry preform is enclosed in a vacuum bag under vacuum and the resin is introduced into the dry preform under vacuum pressure. Resin transfer molding (RTM) may be used where the preform is placed into a closed mold and the resin is injected into the preform under pressure. As will be appreciated, these are all examples and non-limiting.

As used herein, ceramic-matrix-composite or “CMC” refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Generally, a gas turbine engine includes a fan and a turbomachine, with the turbomachine rotating the fan to generate thrust. The turbomachine includes a compressor section, a combustion section, a turbine section, and an exhaust section and defines a working gas flowpath therethrough. With a gas turbine engine gas turbine engine, and in particular with a high-bypass gas turbine engine, the gas turbine engine further defines a bypass ratio characterizing a ratio of a mass flowrate of airflow over the turbomachine to a mass flowrate of airflow through the working gas flowpath (more particularly defined above).

In order to provide high levels of thrust in a relatively efficient manner, certain gas turbine engines includes a relatively large fan. The inventors of the present disclosure sought out to design a gas turbine engine with a fan having an increased efficiency for a desired overall thrust output of the gas turbine engine.

Conventionally, fan blades are formed of a metal material, which generally provides for desirably thin and light fan blades. In some designs, the thickness of the fan blades drives a hub radius for the fan, which in turn affects an overall size of the fan, as a larger hub radius leads to a larger fan radius for a given thrust design point. While forming the fan blades out of metal is a cost effective manufacturing method that is widely used, the inventors found that a size of the fan blades may be limited with such construction due to the mechanical properties of the metal being used.

In particular, the inventors found that by forming fan blades of the fan out of a composite material, a size of the fan blades could be increased (both in radial length and chord length), as the composite material provides improved strength characteristics over certain metal materials traditionally used for fan blade design. This increase in size, the inventors found, allowed for a reduced fan pressure ratio for a given thrust design point of the gas turbine engine. More specifically, by forming the fan blades out of the composite material, the inventors designed the fan to have a lower solidity and lower fan blade count for the given thrust design point of the gas turbine engine as a result of the increased size of the fan blades.

Conventional design has indicated against such a change in fan blade composition, as forming the fan blades out of composite materials generally results in thicker fan blades, which can be challenging at the hub. However, the inventors found that the lower solidity and lower fan blade count allowed for the fan designed by the inventors to unexpectedly have a lower hub radius (particularly at the leading edge of the fan blades), improving efficiency of the fan at the hub, and allowing for overall shorter fan blades as the fan blades can “start” at a closer radial distance to a centerline of the gas turbine engine.

Further, the inventors of the present disclosure found that by including a reduction gearbox, a rotational speed of the fan may be reduced, further reducing the fan pressure ratio of the fan. While slowing the fan blades down too much can result in a stall at the fan during certain operations, by increasing the size of the fan blades, as is allowed through use of the composite fan blades, the inventors found that the fan may still provide for the desired mass flowrate of airflow thereacross to provide the desired thrust output.

In particular, the inventors discovered, unexpectedly, in the course of designing a gas turbine engine having a fan with composite fan blades, that the costs associated with inclusion of a fan with composite fan blades can be overcome by the aeronautical efficiency benefits to the fan in at least certain designs, contrary to previous thinking and expectations. In particular, the inventors discovered during the course of designing several gas turbine engines having fans with composite fan blades of varying thrust classes and aeronautical efficiency requirements (including the configurations illustrated and described in detail herein), a relationship exists among a leading edge tip radius of a fan blade of the fan, a leading edge hub radius of the fan, a trailing edge tip radius of the fan blade of the fan, and a trailing edge hub radius of the fan, whereby including a fan with composite fan blades in accordance with one or more of the exemplary aspects described herein may result in a net benefit to the overall gas turbine engine design. Notably, the leading edge and trailing edge hub radii (for given leading edge and trailing edge tip radii) are driven by, and correlate to, a solidity and fan blade count of the fan, as lower leading edge and trailing edge hub radii (for given leading edge and trailing edge tip radii) require a fan with a lower solidity and a lower fan blade count.

As briefly noted above, previous thinking was to form fan blades out of metal which avoids the costly process of manufacturing components using composite materials. Manufacturing components out of composite materials is either very labor intensive or requires significant upfront automation design costs. The inventors unexpectedly found that by forming the fan blades out of a composite material, the updated designs of the fan that are enabled result in gas turbine engines with aeronautical efficiency improvements that outweighed the challenges associated with manufacturing the fan blades using composite materials.

In particular, with a goal of arriving at an improved gas turbine engine capable of providing an improved aeronautical efficiency, the inventors proceeded in the manner of designing gas turbine engines having a fan (with composite fan blades) with various leading edge tip radii, leading edge hub radii, trailing edge tip radii, and trailing edge hub radii; checking an operability and aeronautical efficiency characteristics of the designed gas turbine engines; redesigning the gas turbine engines to vary the noted parameters based on the impact on other aspects of the gas turbine engines; rechecking the operability and aeronautical efficiency characteristics of the redesigned gas turbine engines; etc. during the design of several different types of fans with composite fan blades, including the fans with composite fan blades described herein, which are described below in greater detail.

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine, sometimes also referred to as a “turbofan engine.” As shown in FIG. 1, the gas turbine engine 10 defines an axial direction A (extending parallel to a longitudinal centerline 12 provided for reference), a radial direction R, and a circumferential direction C extending about the longitudinal centerline 12. In general, the gas turbine engine 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft 34 (which may additionally or alternatively be a spool) drivingly connects the HP turbine 28 to the HP compressor 24. A low pressure (LP) shaft 36 (which may additionally or alternatively be a spool) drivingly connects the LP turbine 30 to the LP compressor 22. The compressor section, combustion section 26, turbine section, and jet exhaust nozzle section 32 together define a working gas flowpath 37.

For the embodiment depicted, the fan section 14 includes a fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 further includes a power gear box 46, and the fan blades 40, disk 42, and pitch change mechanism 44 are together rotatable about the longitudinal centerline 12 by LP shaft 36 across the power gear box 46. The power gear box 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by rotatable front hub 48 of the fan section 14 (sometimes also referred to as a “spinner”). The front hub 48 aerodynamically contoured to promote an airflow through the plurality of fan blades 40.

Additionally, the exemplary fan section 14 includes an annular fan casing or outer nacelle 50 that circumferentially surrounds the fan 38 and/or at least a portion of the turbomachine 16. It should be appreciated that the nacelle 50 is supported relative to the turbomachine 16 by a plurality of circumferentially-spaced outlet guide vanes 52 in the embodiment depicted. Moreover, a downstream section 54 of the nacelle 50 extends over an outer portion of the turbomachine 16 so as to define a bypass airflow passage 56 therebetween.

During operation of the gas turbine engine 10, a volume of air 58 enters the gas turbine engine 10 through an associated inlet 60 of the nacelle 50 and fan section 14. As the volume of air 58 passes across the fan blades 40, a first portion of air 62 is directed or routed into the bypass airflow passage 56 and a second portion of air 64 as indicated by arrow 64 is directed or routed into the working gas flowpath 37, or more specifically into the LP compressor 22. The ratio between the first portion of air 62 and the second portion of air 64 is commonly known as a bypass ratio. A pressure of the second portion of air 64 is then increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, which supports operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, which supports operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the gas turbine engine 10, also providing propulsive thrust. The HP turbine 28, the LP turbine 30, and the jet exhaust nozzle section 32 at least partially define a hot gas path 78 for routing the combustion gases 66 through the turbomachine 16.

It should be appreciated, however, that the exemplary gas turbine engine 10 depicted in FIG. 1 is by way of example only, and that in other exemplary embodiments, the gas turbine engine 10 may have other configurations. For example, although the gas turbine engine 10 depicted is configured as a ducted gas turbine engine (i.e., including the outer nacelle 50, also referred to herein as a turbofan engine), in other embodiments, the gas turbine engine 10 may be an unducted gas turbine engine (such that the fan 38 is an unducted fan, and the outlet guide vanes 52 are cantilevered from the outer casing 18; see, e.g., FIG. 4; also referred to herein as an open rotor engine). Additionally, or alternatively, although the gas turbine engine 10 depicted is configured as a variable pitch gas turbine engine (i.e., including a fan 38 configured as a variable pitch fan), in other embodiments, the gas turbine engine 10 may alternatively be configured as a fixed pitch gas turbine engine (such that the fan 38 includes fan blades 40 that are not rotatable about a pitch axis P).

Referring now to FIG. 2, a close-up view is provided of the fan 38 of the gas turbine engine 10 of FIG. 1, and in particular of a fan blade 40 of the fan 38 of the gas turbine engine 10 of FIG. 1. The fan blade 40 generally defines a leading edge 80, a trailing edge 82, an outer tip 84 along the radial direction R, a base 86 along the radial direction R, and a chord 88 from the leading edge 80 to the trailing edge 82.

Further, it will be appreciated that the fan 38 defines a leading edge (LE) fan radius RFan_LE of the fan blade 40, a trailing edge (TE) fan radius RFan_TE of the fan blade 40, a leading edge hub radius RHub_LE of the fan 38, and a trailing edge hub radius RHub_TE of the fan 38. The leading edge fan radius RFan_LE of the fan blade 40 is a measure along the radial direction R from the longitudinal centerline 12 of the gas turbine engine 10 to the outer tip 84 of the fan blade 40 at the leading edge 80. The trailing edge fan radius RFan_TE of the fan blade 40 is a measure along the radial direction R from the longitudinal centerline 12 of the gas turbine engine 10 to the outer tip 84 of the fan blade 40 at the trailing edge 82. The leading edge hub radius RHub_LE of the fan 38 is a measure along the radial direction R from the longitudinal centerline 12 of the gas turbine engine 10 to the base 86 of the fan blade 40 at the leading edge 80 (where the leading edge 80 meets the spinner/front hub 48). The trailing edge hub radius RHub_TE of the fan 38 is a measure along the radial direction R from the longitudinal centerline 12 of the gas turbine engine 10 to the base 86 of the fan blade 40 at the trailing edge 82 (where the trailing edge 82 meets a casing 90 defining in part an airflow path to receive airflow from the fan 38).

Further, it will be appreciated that the fan blade 40 (and each of the fan blades 40 of the fan 38) are formed of a composite material. It will be appreciated that as used herein, the phrase “formed of a composite material,” with reference to the fan blades 40, refers to at least 80% by weight of the fan blades 40, between the base 86 and the outer tip 84, being formed of one or more composite materials.

As alluded to earlier, the inventors discovered, unexpectedly during the course of designing gas turbine engines having a fan with composite fan blades—i.e., designing gas turbine engines having a fan (with composite fan blades) with various leading edge tip radii, leading edge hub radii, trailing edge tip radii, and trailing edge hub radii, and evaluating an overall engine and aeronautical efficiency performance—a significant relationship between the leading edge tip radii, leading edge hub radii, trailing edge tip radii, and trailing edge hub radii. The relationship can be thought of as an indicator of the ability of a gas turbine engine having a fan with composite fan blades to be able to provide a desired aeronautical efficiency for a given level of desired thrust output for the gas turbine engine. As will be appreciated, and as discussed above, the leading edge and trailing edge hub radii (for given leading edge and trailing edge tip radii) are driven by, and correlate to, a solidity and fan blade count of the fan, enabled by the formation of the fan blades out of composite materials, as lower leading edge and trailing edge hub radii (for given leading edge and trailing edge tip radii) require a fan with a lower solidity and a lower fan blade count.

The relationship applies to a gas turbine engine having a reduction gearbox to reduce a rotational speed of the fan relative to a driving turbine of a turbomachine of the gas turbine engine, a fan having fan blades formed of a composite material, and a high bypass ratio (i.e., a bypass ratio greater than or equal to 10). The relationship ties together a leading edge tip radius of a fan blade of the fan, a leading edge hub radius of the fan, a trailing edge tip radius of the fan blade of the fan, and a trailing edge hub radius of the fan, as described in more detail herein.

In particular, the inventors discovered that when designing a gas turbine engine, inclusion of a fan having fan blades with a large leading edge tip radius, the fan pressure ratio and rotational speed of the fan may be decreased, resulting generally in more efficiency. However, to avoid stall and generate a desired thrust output, a chord of the fan blades needs to be increased to ensure a sufficient airflow is provided through the fan. As the chord of the fan blade increases, the trailing edge tip radius of the fan blades may also increase to achieve a desired fan pressure ratio. Notably, however, the inventors found that increasing the leading edge tip radius too much resulted in increased weight and drag, offsetting the aerodynamic benefits otherwise achieved.

Further, with the chords of the fan blades increasing, the inventors of the present disclosure found that the solidity and fan blade count of the fan may be reduced, which may in turn result in lower leading edge and trailing edge hub radii (despite an increase in individual fan blade thickness as a result of forming the fan blades with composite materials). However, the inventors of the present disclosure found that the trailing edge hub radii could not be reduced too much without negatively affecting aerodynamics of an airflow into an inlet to the turbomachine, and the leading edge hub radii could not deviate too much from the trailing edge hub radii without negatively affecting a fan pressure ratio of the fan.

The relationship discovered, infra, can therefore identify a gas turbine engine having a fan having fan blades formed of a composite material, a reduction gearbox, and a high bypass ratio capable of achieving a desired aeronautical efficiency, while avoiding a prohibitive drag and weight increases, aerodynamic penalties, or combinations thereof and suited for particular mission requirements, one that takes into account efficiency, weight, structural needs for the fan blades, complexity, reliability, and other factors influencing the optimal choice for a gas turbine engine having a fan having fan blades formed of a composite material, a reduction gearbox, and a high bypass ratio.

In addition to yielding an improved gas turbine engine as noted above, utilizing this relationship, the inventors found that the number of suitable or feasible gas turbine engine designs capable of meeting the above design requirements could be greatly diminished, which facilitates a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

One such relationship providing for improved gas turbine engines, discovered by the inventors, is a Fan Leading Edge to Trailing Edge Compression Factor (FLTCF), expressed as:

$$FLTCF = \frac{{R}_{Fan \_ LE} \times {R}_{Hub \_ TE}}{{R}_{Fan \_ TE} \times {R}_{Hub \_ LE}} .$$

In the above expression of FLTCG, R_{Fan_LE} is a leading edge fan radius of a fan blade of a fan of a gas turbine engine, R_{Fan_TE} is a trailing edge fan radius of the fan blade of the fan of the gas turbine engine, R_{Hub_LE} is a leading edge hub radius of the fan of the gas turbine engine, and R_{Hub_TE} is a trailing edge hub radius of the fan of the gas turbine engine.

Another such relationship providing for the improved gas turbine engines, discovered by the inventors, is a Fan Leading Edge to Trailing Edge Opening Ratio (FLTOR), expressed as:

$$FLTOR = \frac{{R}_{Fan \_ LE} - {R}_{Hub \_ LE}}{{R}_{Fan \_ TE} - {R}_{Hub \_ TE}} .$$

In the above expression of FLTCG, R_{Fan_LE} is a leading edge fan radius of a fan blade of a fan of a gas turbine engine, R_{Fan_TE} is a trailing edge fan radius of the fan blade of the fan of the gas turbine engine, R_{Hub_LE} is a leading edge hub radius of the fan of the gas turbine engine, and R_{Hub_TE} is a trailing edge hub radius of the fan of the gas turbine engine.

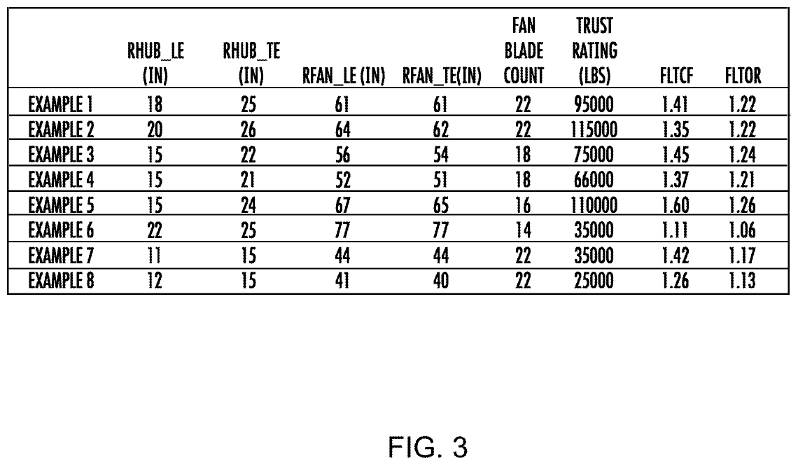

Example engines in accordance with one or more exemplary embodiments of the present disclosure are provided in the table of FIG. 3. The FLTCF is valid only when it is greater than or equal to 1.05 and less than or equal to 1.8. For example, in certain exemplary embodiments, the FLTCF is greater than or equal to 1.07 and less than or equal to 1.65. Further, the FLTOR is valid only when it is greater than or equal to 1.03 and less than or equal to 1.5. For example, in certain exemplary embodiments, the FLTOR is greater than or equal to 1.05 and less than or equal to 1.3. These and other aspects of FLTCF and FLTOR in which these relationships are valid are set forth below in Table 1. FLTCF and FLTOR are not valid outside of the ranges in Table 1.

TABLE 1

| Symbol | Description | FLTCP, FLTOR |
|---|---|---|
| R_{Fan}_LE | Leading edge fan radius of | 20 inches to 85 inches, such |
| | a fan blade of a fan of a gas | as 35 inches to 80 inches |
| | turbine engine | |
| R_{Fan}_TE | Trailing edge fan radius of the | 20 inches to 85 inches, such |
| | fan blade of the fan of the gas | as 35 inches to 68 inches |
| | turbine engine | |
| R_{Hub}_LE | Leading edge hub radius of the | 5 inches to 30 inches, such as |
| | fan of the gas turbine engine | 6 inches to 25 inches |
| R_{Hub}_TE | Trailing edge hub radius of the | 5 inches to 30 inches, such as |
| | fan of the gas turbine engine | 6 inches to 25 inches |
| FLTCF | Fan Leading Edge to Trailing | 1.05 to 1.8, such as 1.07 to |
| | Edge Compression Factor | 1.65 |
| FLTOR | Fan Leading Edge to Trailing | 1.03 to 1.5, such as 1.05 to |
| | Edge Opening Ratio | 1.3 |

Notably, each of exemplary engines noted in FIG. 3 defines a bypass ratio greater than or equal to 10 and less than or equal to 100, such as greater than or equal to 13, such as greater than or equal to 15, and less than or equal to 85, such as less than or equal to 70, such as less than or equal to 25. Further, each of the exemplary engines noted in FIG. 3 includes a reduction gearbox (and thus may be referred to as a geared gas turbine engine) defining a gear ratio greater than or equal to 2 and less than or equal to 14.

For example, in one exemplary embodiment, the gas turbine engine may be an unducted gas turbine engine (also referred to as an “open rotor engine”) including an unducted fan having fan blades formed of a composite material (see, e.g., the embodiment of FIG. 4, described below). In such an exemplary embodiment, a leading edge fan radius R_{Fan_LE} of a fan blade of the fan is greater than or equal to 65 inches and less than or equal to 85 inches, the fan defines a fan blade count greater than or equal to 5 and less than or equal to 15, a reduction gearbox defines a gear ratio greater than 4 and less than 12, and a thrust rating for the engine is between 20,000 pounds and 45,000 pounds. With such an exemplary embodiment the FLTCF is greater than or equal to 1.07 and less than or equal to 1.25, and the FLTOR is greater than or equal to 1.03 and less than or equal to 1.12. In such a manner, it will be appreciated that forming the fan blades of a composite material with this exemplary gas turbine engine enabled a size of the fan (both radially and in a chordwise direction) to be increased, allowing for a desired thrust output, despite a reduction in the fan blade count of the fan and solidity of the fan blades. Example 6 in FIG. 3 is an exemplary embodiment of such a gas turbine engine.

Further for example, in another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 35 inches and less than or equal to 50 inches, the fan defines a fan blade count greater than or equal to 12 and less than or equal to 23, a reduction gearbox defines a gear ratio greater than 2 and less than 4, and a thrust rating for the engine is between 20,000 pounds and 45,000 pounds. With such an exemplary embodiment the FLTCF is greater than or equal to 1.12 and less than or equal to 1.35, and the FLTOR is greater than or equal to 1.06 and less than or equal to 1.19. In such a manner, it will be appreciated that forming the fan blades of a composite material with this exemplary gas turbine engine enabled a size of the fan (e.g., in a chordwise direction) to be increased, allowing for a desired thrust output, despite a potential reduction in the fan blade count of the fan and solidity of the fan blades. Example 8 in FIG. 3 is an exemplary embodiment of such a gas turbine engine.

For example, in yet another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 51 inches and less than or equal to 66 inches, the fan defines a fan blade count greater than or equal to 17 and less than or equal to 23, a reduction gearbox defines a gear ratio greater than 1 and less than 4, and a thrust rating for the engine is between 60,000 pounds and 118,000 pounds. With such an exemplary embodiment the FLTCF is greater than or equal to 1.27 and less than or equal to 1.5, and the FLTOR is greater than or equal to 1.18 and less than or equal to 1.25. In such a manner, it will be appreciated that forming the fan blades of a composite material with this exemplary gas turbine engine enabled a size of the fan (e.g., in a radial direction and in a chordwise direction) to be increased, allowing for a desired thrust output, despite a potential reduction in the fan blade count of the fan and solidity of the fan blades. Examples 1 through 4 in FIG. 3 are exemplary embodiments of such a gas turbine engine.

Further for example, in still another exemplary embodiment, the gas turbine engine is a ducted gas turbine engine including an outer nacelle surrounding at least in part a fan of the gas turbine engine, with the fan having fan blades formed of a composite material (see, e.g., the embodiment of FIGS. 1 and 2, described above). In such an exemplary embodiment, a leading edge fan radius R_{Fan_LE} of a fan blade of the fan is greater than or equal to 55 inches and less than or equal to 70 inches, the fan defines a fan blade count greater than or equal to 12 and less than or equal to 22 (e.g., less than or equal to 19), a reduction gearbox defines a gear ratio greater than 1 and less than 4, and a thrust rating for the engine is between 100,000 pounds and 150,000 pounds (such as greater than 118,000 pounds and less than 150,000 pounds). With such an exemplary embodiment the FLTCF is greater than or equal to 1.46 and less than or equal to 1.65, and the FLTOR is greater than or equal to 1.2 and less than or equal to 1.5 (such as greater than or equal to 1.25 and less than 1.5). In such a manner, it will be appreciated that forming the fan blades of a composite material have enabled a size of the fan (e.g., in a radial direction and in a chordwise direction) to be increased, allowing for a desired thrust output, despite a potential reduction in the fan blade count of the fan and solidity of the fan blades. Example 5 in FIG. 3 is an exemplary embodiments of such a gas turbine engine.

Referring now to FIG. 4, a schematic cross-sectional view of a gas turbine engine 100 is provided according to another example embodiment of the present disclosure. The exemplary gas turbine engine 100 of FIG. 4 may be configured in substantially the same manner as the exemplary gas turbine engine 100 described above with reference to FIGS. 1 and 2.

For example, the exemplary gas turbine engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

Further, the exemplary gas turbine engine 100 generally includes a fan section 150 and a turbomachine 120. Generally, the turbomachine 120 includes, in serial flow order, a compressor section, a combustion section, a turbine section, and an exhaust section. Particularly, as shown in FIG. 4, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126; a high pressure (“HP”) compressor 128; a combustor 130; a high pressure turbine 132; and a low pressure turbine 134. The high pressure turbine 128 drives the high pressure compressor 128 through a high pressure shaft 136. The low pressure turbine 134 drives the low pressure compressor 126 and components of the fan section 150 through a low pressure shaft 138, and as such may be referred to as a drive turbine. After driving each of the turbines 132, 134, combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. By contrast to the embodiment of FIG. 1, for the depicted embodiment of FIG. 4, the fan 152 is an open rotor or unducted fan 152. In such a manner, the gas turbine engine 100 may be referred to as an open rotor engine.

As depicted, the fan 152 includes an array of fan blades 154 (only one shown in FIG. 4). The fan blades 154 are rotatable, e.g., about the longitudinal axis 112. As noted above, the fan 152 is drivingly coupled with the low pressure turbine 134 via the LP shaft 138. As with the exemplary embodiments discussed above, the fan blades 154 are formed of a composite material.

Further for the embodiments shown in FIG. 4, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. Each fan blade 154 defines a central blade axis 156. For this embodiment, each fan blade 154 of the fan 152 is rotatable about its central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 4) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 4 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to the fan cowl 170.

By contrast to the embodiment of FIG. 1, as shown in FIG. 4, in addition to the unducted fan 152, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the low pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 4) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 4). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between the engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. In the embodiment depicted, the inlet duct 180 is wider than the core duct 142 along the radial direction R. The inlet duct 180 is also wider than the fan duct 172 along the radial direction R.

Moreover, referring still to FIG. 4, in exemplary embodiments, air passing through the fan duct 172 may be relatively cooler (e.g., lower temperature) than one or more fluids utilized in the turbomachine 120. In this way, one or more heat exchangers 186 may be positioned in thermal communication with the fan duct 172. For example, one or more heat exchangers 186 may be disposed within the fan duct 172 and utilized to cool one or more fluids from the core engine with the air passing through the fan duct 172, as a resource for removing heat from a fluid, e.g., compressor bleed air, oil or fuel.

Although not depicted in the example of FIG. 4, the heat exchanger 186 may be an annular heat exchanger extending substantially 360 degrees in the fan duct 172 (e.g., at least 300 degrees, such as at least 330 degrees). In such a manner, the heat exchanger 186 may effectively utilize the air passing through the fan duct 172 to cool one or more systems of the engine 100 (e.g., lubrication oil systems, compressor bleed air, electrical components, etc.). The heat exchanger 186 uses the air passing through duct 172 as a heat sink and correspondingly increases the temperature of the air downstream of the heat exchanger 186 and exiting the fan exhaust nozzle 178.

As will be appreciated from the description herein, various other embodiments of a gas turbine engine are provided. Certain of these embodiments may be an unducted, single rotor gas turbine engine, or a ducted gas turbine engine. Various additional aspects of one or more of these embodiments are discussed below. These exemplary aspects may be combined with one or more of the exemplary gas turbine engine(s) discussed above with respect to the figures.

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 pounds per square inch absolute (psia) and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps.

A fan pressure ratio (FPR) for the fan of the fan assembly can be 1.04 to 1.20, or in some embodiments 1.05 to 1.1, or in some embodiments less than 1.08, as measured across the fan blades at a cruise flight condition.

In order for the gas turbine engine to operate with a fan having the above characteristics and provide the benefits noted herein associated with forming the fan blades from a composite material, a gear assembly may be provided to reduce a rotational speed of the fan assembly relative to a driving shaft (such as a low pressure shaft coupled to a low pressure turbine). In some embodiments, a gear ratio of the input rotational speed to the output rotational speed is greater than or equal to 2. For example, in particular embodiments, the gear ratio is within a range of 4.1 to 14.0, within a range of 4.5 to 14.0, or within a range of 6.0 to 14.0. In certain embodiments, the gear ratio is within a range of 4.5 to 12 or within a range of 6.0 to 11.0. As such, in some embodiments, the fan can be configured to rotate at a rotational speed of 700 to 1500 revolutions per minute (rpm) at a cruise flight condition, while the power turbine (e.g., the low-pressure turbine) is configured to rotate at a rotational speed of 2,500 to 15,000 rpm at a cruise flight condition. In particular embodiments, the fan can be configured to rotate at a rotational speed of 850 to 1,350 rpm at a cruise flight condition, while the power turbine is configured to rotate at a rotational speed of 5,000 to 10,000 rpm at a cruise flight condition.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor may include 1 to 8 stages, a high-pressure compressor may include 8 to 15 stages, a high-pressure turbine may include 1 to 2 stages, and/or a low pressure turbine (LPT) may include 3 to 7 stages. In particular, the LPT may have 4 stages, or between 4 and 7 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

In certain aspects of the present disclosure, the gas turbine engine is a ducted gas turbine engine that further includes an actuatable nacelle assembly. In such configurations, a portion of the nacelle assembly, such as a translating cowl associated with a thrust reverser system, is movable to vary an effective area of a fan nozzle during certain operating conditions.

The inclusion of an actuatable nacelle assembly allows for adjusting an operating line of the fan of the ducted gas turbine engine for improved performance or stability. For example, the translating cowl can be moved to create an auxiliary airflow path from the bypass passage and change an effective fan nozzle exit area during different flight phases to improve propulsive efficiency. This allows the operating line of the fan to be designed for specific conditions, such as a smaller nozzle area for high-efficiency cruise flight and a larger area for high-thrust takeoff. Additionally, the translating cowl can be moved to create the auxiliary airflow path from the bypass passage and change the effective fan nozzle exit area to unload fan blades of the fan during certain low-power conditions. This effectively increases a total exit area available to the fan, which can alleviate aerodynamic instabilities that may occur when operating at the low fan pressure ratios associated with, e.g., ground operations.

Combining such an actuatable nacelle assembly with a gas turbine engine meeting the constraints of the FLTCF and FLTOR relationships described herein provides for unexpected and complementary benefits. As will be appreciated, a gas turbine engine meeting these constraints utilizes composite fan blades and a geared architecture to enable a large, slow-turning, and efficient fan. Such a fan arrangement is designed to operate at a relatively low fan pressure ratio to achieve high propulsive efficiency. However, operation at low fan pressure ratios, particularly during off-design or low-power conditions like taxiing, may increase a susceptibility of the fan to aerodynamic instabilities, such as fan flutter. The partial deployment of a translating cowl, as described in aspects of the present disclosure, provides an auxiliary airflow path that unloads the fan blades. Such an arrangement can improve a stability margin of the fan, directly addressing a potential operational challenge introduced by the highly efficient, low-pressure-ratio design of the baseline engine configuration.

Moreover, the specific geometric relationships of the fan defined by the FLTCF and FLTOR parameters are selected to provide a high level of aeronautical efficiency, for example, at a cruise operating condition. The ability to actively vary the effective exit area of the fan nozzle via the translating cowl during flight allows for further improvements to a performance of the gas turbine engine across a wider range of operating conditions, such as takeoff and climb. This allows the propulsive efficiency benefits of a composite fan of a gas turbine engine meeting the constraints of the FLTCF and FLTOR relationships to be extended across more of the flight envelope. Incorporating the translating cowl into such a gas turbine engine therefore results in a gas turbine engine that not only possesses the high cruise efficiency described above but also has enhanced operational flexibility and stability.

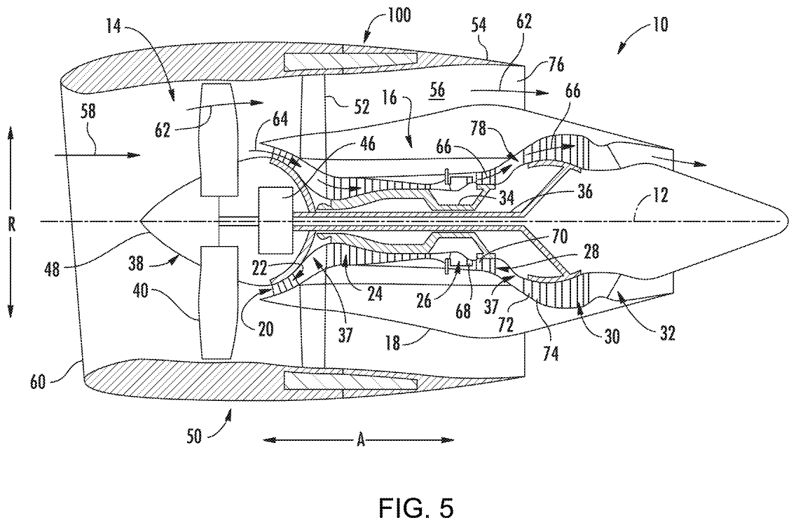

Referring now to FIG. 5, a schematic cross-sectional view of a gas turbine engine in accordance with another exemplary embodiment of the present disclosure is provided. The exemplary gas turbine engine 10 of FIG. 5 may be configured in substantially the same manner as the exemplary gas turbine engine 10 of FIG. 1. For example, for the embodiment of FIG. 5, the gas turbine engine 10 defines an axial direction A (extending parallel to a longitudinal centerline 12 provided for reference) and a radial direction R. The gas turbine engine 10 may also define a circumferential direction (not shown) extending circumferentially about the axial direction A. Additionally, the gas turbine engine 10 includes a fan section 14 and a turbomachine 16 disposed downstream from the fan section 14. The exemplary gas turbine engine 10 includes an annular nacelle assembly 50 that circumferentially surrounds a fan 38 of the fan section 14 and/or at least a portion of the turbomachine 16.

However, as will be discussed in greater detail with reference to the exemplary embodiments below, the nacelle assembly 50 includes a thrust reverser system 200, which is depicted in a fully stowed position.

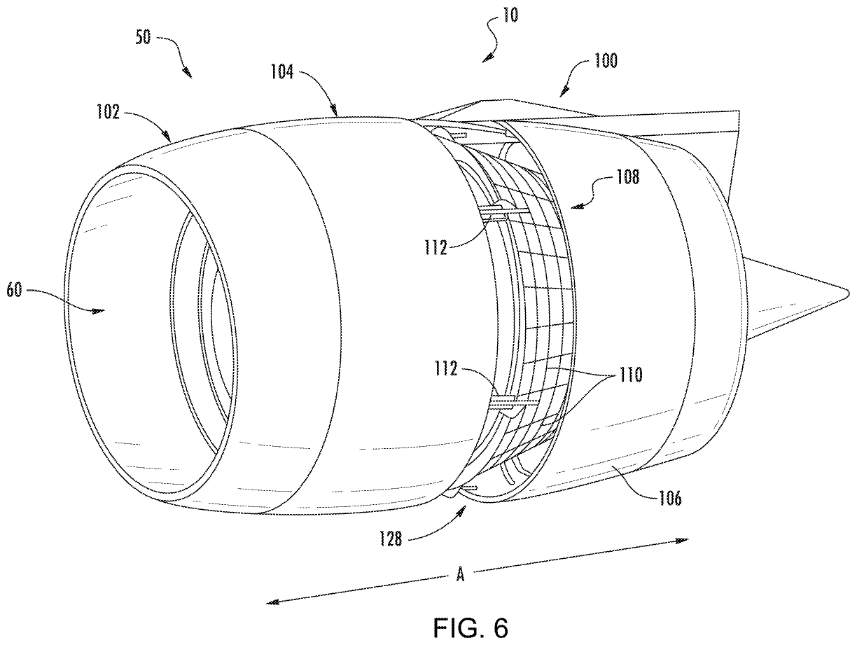

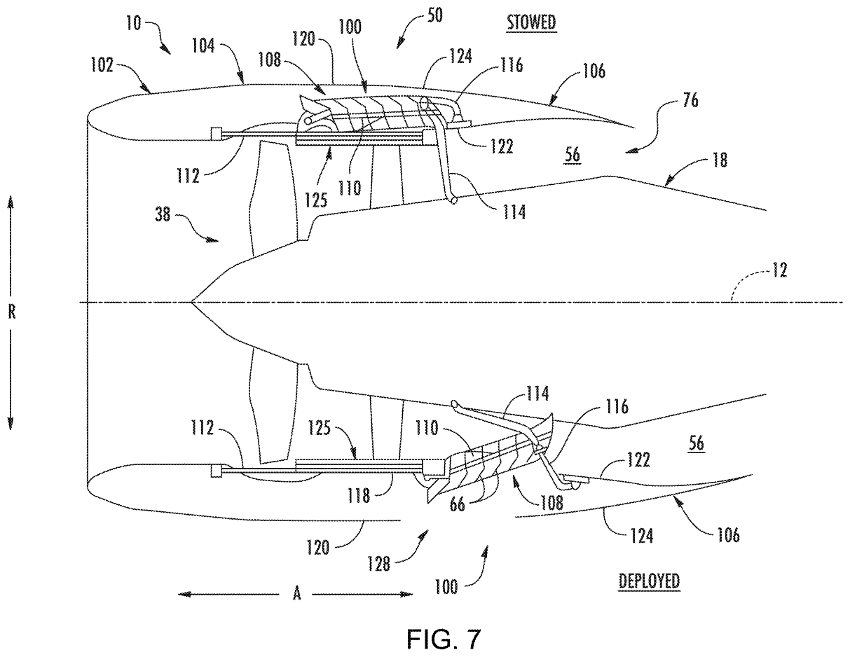

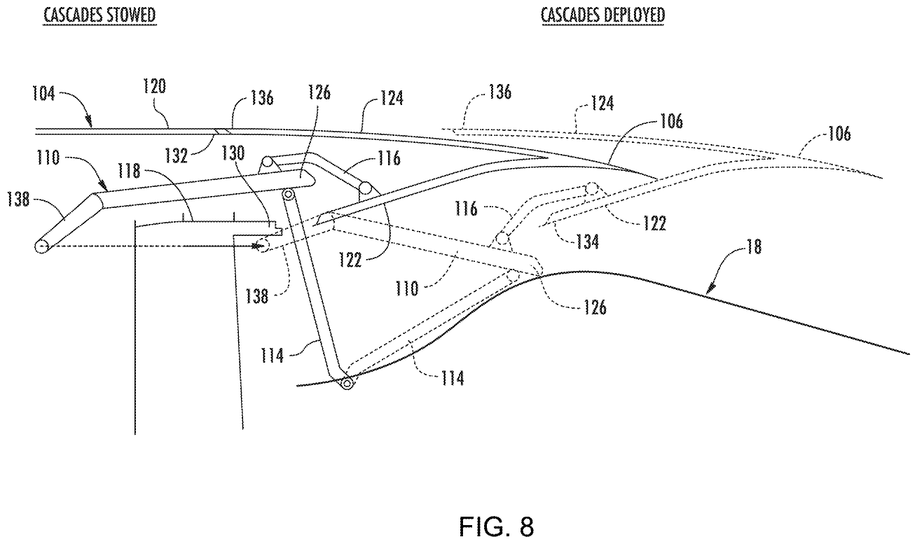

Referring now to FIGS. 6 through 8 a gas turbine engine 10 in accordance with another exemplary embodiment of the present disclosure is provided. The exemplary gas turbine engine 10 depicted in FIGS. 6 through 8 includes a thrust reverser system 200 in accordance with an exemplary embodiment of the present disclosure. Specifically, FIG. 6 provides a perspective view of the exemplary gas turbine engine 10 with the thrust reverser system 200 in a fully deployed position; FIG. 7 provides a cross-sectional schematic view of the exemplary gas turbine engine 10 along an axial direction A, a top half of which depicting the thrust reverser system 200 in a fully stowed position and a bottom half of which depicting the thrust reverser system 200 in a fully deployed position; and FIG. 8 provides a close up, schematic view of the exemplary thrust reverser system 200. The exemplary gas turbine engine 10 of FIGS. 6 through 8 may be configured in substantially the same manner as the exemplary gas turbine engine 10 of FIG. 5. Accordingly, the same numbering may refer to the same or functionally equivalent components.

As depicted, a nacelle assembly 50 of the gas turbine engine 10 generally includes an inlet assembly 202, a fan cowl 204, and the thrust reverser system 200. The inlet assembly 202 is positioned at a forward end of the nacelle assembly 50 and the fan cowl 204 is positioned aft of the inlet assembly 202 and at least partially surrounds the fan 38. The thrust reverser system 200 is, in turn, positioned at least partially aft the fan cowl 204. As is depicted, an outer casing 18 of a turbomachine 16 defines a radially inward boundary of a bypass passage 56 and the nacelle assembly 50 defines a radially outward boundary of the bypass passage 56. Bypass air of the engine 10 passes through the bypass passage 56 and exits through a fan exit nozzle 76 during certain operations.

The thrust reverser system 200 of FIGS. 6 through 8 includes a translating cowl (transcowl) 206 slidably mounted to the fan cowl 204, and a cascade system 208. As evident from FIG. 6, the transcowl 206 is the aft-most section of the nacelle assembly 50, located aft of the fan cowl 204 and circumscribing the outer casing 18 of the turbomachine 16. When in a fully deployed position (see FIG. 6 and bottom portion of FIG. 7), the cascade system 208 is also located aft of the fan cowl 204 and circumscribes the outer casing 18 of the turbomachine 16. By contrast, when in a fully stowed position (see top portion of FIG. 7) the cascade system 208 is stowed at least partially within the fan cowl 204. Furthermore, as the cascade system 208 is stowed at least partially within the fan cowl 204 when in the fully stowed position (and slides/translates into the deployed position), inclusion of the cascade system 208 may not add to an overall axial length of the nacelle assembly 50.

The cascade system 208 is depicted formed of/including a plurality of individual cascade segments 210 that are circumferentially spaced around a circumference of the nacelle assembly 50. As evident from FIGS. 7 and 8, the segments 210 of the cascade system 208 are adapted to deploy from a fully stowed position, shown in the upper half of FIG. 7 and shown in the detailed view of FIG. 8, to a fully deployed position shown in the lower half of each of FIG. 7 and shown in phantom in FIG. 8. For the embodiment depicted, the transcowl 206 and cascade system 208 are adapted to be translated in unison in an aft direction of the engine 10 when the thrust reverser system 200 is moved from the fully stowed position to the fully deployed position (i.e., deployed). More particularly, to deploy the cascade system 208 into the bypass passage 56, the transcowl 206 is moved aftwardly from the fan cowl 204 generally along the axial direction A and the cascade system 208 is pivoted into the bypass passage 56, causing a flow of bypass air within the passage 56 to be diverted through the deployed cascade system 208 to provide a thrust reversal effect. For this purpose, FIGS. 6 through 8 represent the cascade segments 210 as pivotally coupled to the nacelle assembly 50 through respective actuators 212 mounted to the nacelle assembly 50. The actuators 212 are configured to move the thrust reverser system 200 from the fully stowed position to the fully deployed position. The actuators 212 can be of any suitable type and can be driven by, e.g., pneumatic, hydraulic, or electric motors. Additionally, the cascade systems 210 are depicted being coupled to a fixed structure of the nacelle assembly 50 with guided connections 225. Further, FIGS. 7 and 8 represent the cascade segments 210 as pivotally coupled to the outer casing 18 of the turbomachine 16 with drag links 214, and represent the transcowl 206 as pivotally coupled to the cascade segments 210 through links 216 for translation therewith.

Translation of the cascade system 208 and transcowl 206 in the aft direction along the axial direction A causes the cascade segments 210 to be deployed into the bypass passage 56 in a manner represented in FIGS. 7 and 8. From these figures it can be appreciated that, when fully stowed, the cascade segments 210 are enclosed and completely concealed between inner and outer engine fan cases 218, 220 of the fan cowl 204 and the inner and outer walls 222, 224 of the transcowl 206. Accordingly, when the thrust reverser system 200 is fully stowed, the inner engine fan case 218 and the inner wall 222 of the transcowl 206 define a portion of the radially outer flow surface of the bypass passage 56 and completely separate the cascade system 208 from the duct 56. An advantage of this configuration is that the thrust reverser system 200 of this invention does not have blocker doors that define any portion of the radially outer flow surface of the bypass passage 56 during normal engine operation. Consequently, the thrust reverser system 200 can be configured to avoid surface interruptions (gaps and steps) and duct leakage that would increase aerodynamic drag and reduce aerodynamic performance of the engine 10 when the thrust reverser system 200 is in the fully stowed position. Another advantage is that the entire inner wall 222 of the transcowl 206 can incorporate an uninterrupted acoustic treatment (not shown) of its entire surface area to promote increased engine noise attenuation.

By contrast, when moved to the fully deployed position, the cascade segments 210 of the thrust reverser system 200 may, but are not required to, extend entirely across a radial width of the duct 56 so that its aft end 226 contacts, or nearly contacts, the outer casing 18 of the turbomachine 16. As represented in FIG. 7, as bypassed air within the duct 56 encounters the cascade system 208, the air is diverted by grid openings in the segments 210 and expelled through a circumferential opening 228 defined between the aft ends 230, 232 of the inner and outer engine fan cases 218, 220 and the forward ends 234, 236 of the inner and outer walls 222, 224 of the transcowl 206 (FIG. 8). As depicted in FIG. 7, each segment 210 can be equipped with an extension that promotes the capture of air flowing along the outer surface of the outer casing 18 of the turbomachine 16.

As evident from the above, the embodiment depicted incorporates to some extent a conventional role of a blocker door function into the cascade system 208, and does so by adding rotation to the traditional translating motion of cascades. To serve in this role, each cascade segment 210 must have a sufficient length and be sufficiently angled downward to, in certain embodiments, completely block the fan bypass passage 56. For this reason, it is likely that the segments 210 may be longer than fixed cascades that may otherwise be employed in the gas turbine engine 10.

It should be appreciated, however, that the exemplary thrust reverser system 200 depicted is provided by way of example only, and that in other exemplary embodiments, the thrust reverser system 200 may have any other suitable configuration. For example, while the embodiment of FIGS. 6 through 8 depict each cascade segment 210 as equipped with two different links 214 and 216 rotatably coupled near the aft end 226 of each segment 210 to impart and control the rotational movement of the segment 210 during deployment, in other exemplary embodiments the link 214 may be eliminated in order to further decrease aerodynamic drag and other flow perturbations that can cause aerodynamic or acoustic inefficiencies. Additionally, it should be appreciated that the translational-rotational motion of the cascade segments 210 are not dependent on any particular type of cascade design, aside from the requirement that the cascade system 208 is capable of turning the air flow within the bypass passage 56. For example, in still other embodiments, the thrust reverser system 200 may not include either of the links 214, 216 shown, and instead may, e.g., rely on a geometry of the cascade system 208 and a kinematic deployment system. Furthermore, whereas the cascade segments 210 represented in FIGS. 6 through 8 have rigid constructions that do not intentionally bend, flex or fold during deployment, cascade segments 210 having any of these capabilities are also within the scope of the present disclosure. Finally, it should also be appreciated that the thrust reverser system 200 and its individual components can be constructed of various materials, including metallic, plastic and composite materials commonly used in aerospace applications and fabricated by machining, casting, molding, lamination, etc., and combinations thereof.

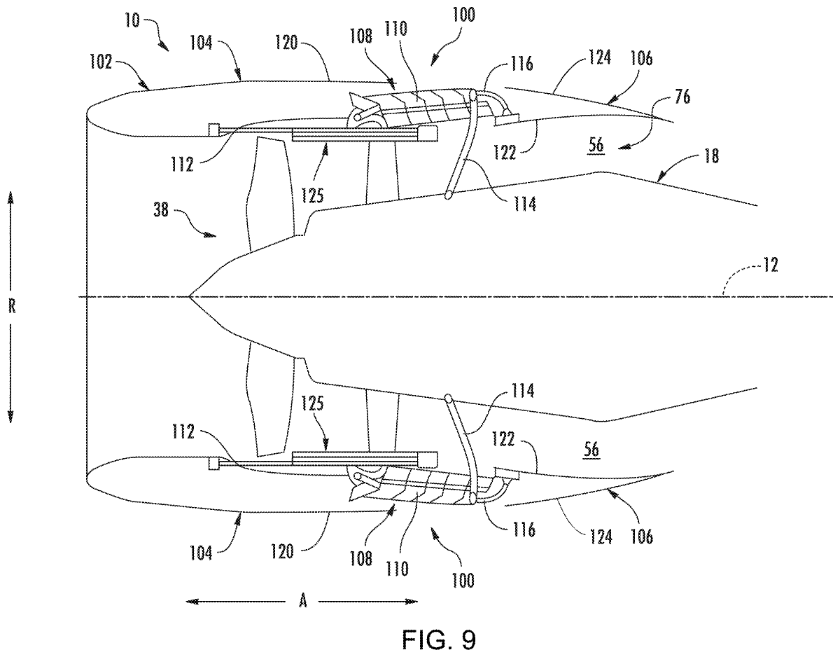

Referring particularly to FIG. 7, and now also to FIG. 9, movement of the thrust reverser system 200 between the fully stowed position and the fully deployed position includes at least two distinct phases during deployment of the thrust reverser system 200. During an initial/“aft movement” phase, each cascade segment 210 translates aftward with the transcowl 206 relative to the fan cowl 204, generally along the axial direction A, with minimal rotational movement between the segments 210 and fan cowl 204. During a subsequent/“rotational movement” phase, with further aftward movement of the forward end 238 of the cascade segment 210 coupled to its actuator 212, each cascade segment 210 pivots about its forward end 238 as a result of the drag link 214 restricting aftward movement of the aft end 226 of the segment 210, causing the aft end 226 to move radially inward toward the outer casing 18 of the turbomachine 16 until each segment 210 assumes its fully deployed position and extends across the radial width of the duct 56.

Notably, however, the exemplary gas turbine engine 10 depicted in FIG. 9 is configured to hold the thrust reverser system 200 in a partially deployed position (see FIG. 9) during certain operations. More particularly, the thrust reverser system 200, as discussed, is deployed from the fully stowed position to the fully deployed position through two distinct phases. For the embodiment depicted, gas turbine engine 10 is configured to stop a movement of the thrust reverser system 200 during, or at the end of, the initial aft movement phase in what is referred to herein as the “partially deployed position,” and hold the thrust reverser system 200 in such partially deployed position. When the exemplary thrust reverser system 200 is positioned in the partially deployed position, the thrust reverser system 200 allows an additional amount of airflow to exit radially from the bypass passage 56, while the gas turbine engine 10, and more particularly the fan 38, continue to generate a net forward thrust.

Further to the above discussion, in order to move the thrust reverser system 200 from the fully stowed position to the partially deployed position, the transcowl 206 of the thrust reverser system 200 is moved aftwardly away from the fan cowl 204 generally along the axial direction A, such that the nacelle assembly 50 defines the opening 228 between the fan cowl 204 and the transcowl 206. The opening 228 may generally be an annular opening. Additionally, in at least certain exemplary embodiments, the opening 228 defined between the fan cowl 204 and the transcowl 206 when the thrust reverser system 200 is in the partially deployed position may be at least about three inches long along the axial direction A. Alternatively, however, in other exemplary embodiments, the opening 228 may instead be at least about five inches long along the axial direction A, at least about seven inches long along the axial direction A, or at least about nine inches long along the axial direction A. For example, a length of the opening 228 defined between the fan cowl 204 and the transcowl 206 when the thrust reverser system 200 is in the partially deployed position may be at least about 2% of a diameter of the fan 38 (along the radial direction R), at least about 4% of a diameter of the fan 38, at least about 6% of a diameter of the fan 38, or any other suitable size. It should be appreciated, that as used herein, terms of approximation, such as “about” or “approximate,” refer to being within a ten percent margin of error.

Notably, when the exemplary thrust reverser system 200 is in the partially deployed position, a majority of the components of the thrust reverser system 200 remain outside of the bypass passage 56. For example, when the exemplary thrust reverser system 200 is in the partially deployed position, the cascade segments 210 of the thrust reverser system 200 remain at a location substantially outside of the bypass passage 56, as the cascade segments 210 have not pivoted inwardly.

Moreover, as briefly discussed above, moving the thrust reverser system 200 to the partially deployed position may allow for an additional amount of airflow to exit the bypass passage 56. Accordingly, in effect, moving the thrust reverser system 200 to the partially deployed position allows the gas turbine engine 10 to define a larger effective fan nozzle throat area (i.e., at nozzle section 76). More particularly, for the embodiment depicted, moving the thrust reverser system 200 to the partially deployed position, such that the nacelle assembly 50 defines the opening 228 between the transcowl 206 and the fan cowl 204, allows for at least about fifteen percent of an airflow through the bypass passage 56 (i.e., bypassed air) to exit through the opening 228 during operation. However, in other exemplary embodiments, moving the thrust reverser system 200 to the partially deployed position may further allow for at least about twenty percent, at least about twenty-five percent, or at least about thirty percent of an airflow through the bypass passage 56 to exit through the opening 228 during operation. In any of the above embodiments, moving the thrust reverser system 200 to the partially deployed position allows for an increased overall airflow through the bypass passage 56 as the opening 228 provides a path for the airflow through the bypass passage 56 to flow in addition to the fan nozzle throat area (i.e., the nozzle section 76).

A gas turbine engine 10 including a nacelle assembly 50 configured in such a manner may be configured to hold the thrust reverser system 200 in the partially deployed position when the fan defines a relatively low fan pressure ratio (i.e., a pressure ratio across the fan 38). For example, the gas turbine engine 10 may be configured to hold the thrust reverser system 200 in the partially deployed position when the fan 38 defines a fan pressure ratio of less than about two (2), or further less than about one and a half (1.5), less than about 1.35, or less than about 1.25. Such a configuration may minimize an amount of aeromechanical flutter instability during operation of the fan 38 at such relatively low fan pressure ratios. More particularly, by holding the thrust reverser system 200 in the partially deployed position, the increased effective fan nozzle area may unload a portion of an airflow from the fan blades 40 to alleviate an aeromechanical flutter instability of such fan blades 40.

In at least certain exemplary embodiments, operating the fan 38 at a relatively low fan pressure ratio may correspond to times in which a relatively low amount of thrust is required from the fan 38. For example, operating the fan 38 at a relatively low fan pressure ratio may correspond to a taxiing operating mode of the gas turbine engine 10, i.e., a taxiing operating mode of an aircraft to which the gas turbine engine 10 is mounted. Accordingly, in certain exemplary embodiments, the gas turbine engine 10 may be configured to hold the thrust reverser system 200 in the partially deployed position when the gas turbine engine 10 is operated in a taxiing operating mode.

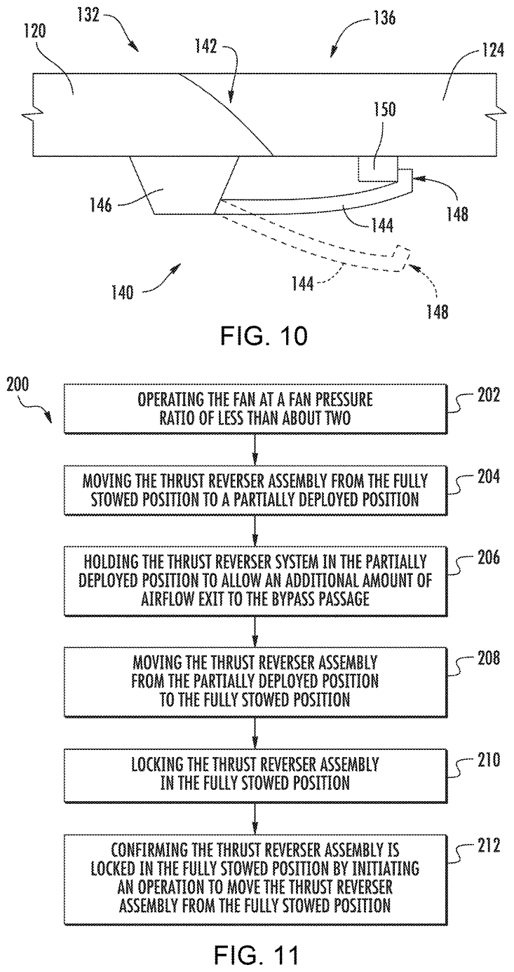

Further, in order to ensure the thrust reverser system 200 is not unintentionally moved to the partially deployed position (or the fully deployed position) during other operating modes of the gas turbine engine 10, the exemplary nacelle assembly 50 may further includes a locking mechanism 240 configured to block the thrust reverser system 200 from movement when the thrust reverser system 200 is in the fully stowed position. For example, referring now to FIG. 10, a close-up, schematic view is provided of a nacelle assembly 50 in accordance with an exemplary embodiment of the present disclosure including an exemplary locking mechanism 240. More particularly, FIG. 10 depicts a juncture 242 between an exemplary transcowl 206 and a fan cowl 204 when a thrust reverser system 200 is in a fully stowed position. The juncture 242 may include a sealing feature (e.g., an elastomeric seal or gasket between the fan cowl 204 and transcowl 206) to prevent any air leakage when the thrust reverser system 200 is in the stowed position. The locking mechanism 240 generally includes a lever 244 rotatably attached to an actuator 246 positioned on the fan cowl 204, the lever 244 having a hook 248 at a distal end. The hook 248 of the lever 244 engages with a stop block 250 on the transcowl 206 when the locking mechanism 240 is in the locked position (shown), to prevent movement of the transcowl 206 relative to the fan cowl 204. By contrast, when the locking mechanism 240 is in an unlocked position (shown in phantom), the hook 248 of the lever 244 is disengaged with the stop block 250 on the transcowl 206, such that the transcowl 206 may move generally along the axial direction A relative to the fan cowl 204. The locking mechanism 240 may be operated independently of the thrust reverser system 200. Accordingly, the locking mechanism 240 may be checked to ensure its operation by activating the locking mechanism 240 and independently attempting to move the thrust reverser system 200 from the fully stowed position.

It should be appreciated, however, that the exemplary locking mechanism 240 depicted is provided by way of example only, and that in other exemplary embodiments, any other suitable locking mechanism 240 may be provided. For example, in other exemplary embodiments, the locking mechanism 240 may include a retractable pin configured with a slot to releasably lock the transcowl 206 to the fan cowl 204. Further, in other embodiments, the locking mechanism 240 may be manually or automatically controlled independently of the thrust reverser system 200. For example, the locking mechanism may be automatically controlled in response to a sensor configured to determine when one or more wheels of an airplane to which the gas turbine engine 10 is attached are on the ground (e.g., a weight sensor).

Referring now to FIG. 11, a flow diagram is provided of an exemplary method (300) for operating a gas turbine engine in accordance with an exemplary aspect of the present disclosure. For example, the exemplary method (300) may be configured for operating a gas turbine engine comprising a fan, a core in flow communication with the fan, and a nacelle assembly enclosing the fan and at least a portion of the core to define a bypass passage with the core. Additionally, the nacelle assembly of the gas turbine engine operated by the exemplary method (300) may include a thrust reverser system movable between a fully stowed position and a fully deployed position. Accordingly, the exemplary method (300) may be configured to operate the gas turbine engine 10 discussed above with reference to FIGS. 6 through 9.

The exemplary method (300) includes at (302) operating the fan at a fan pressure ratio of less than about two. However, in other exemplary aspects, operating the fan and a fan pressure ratio of less than about two at (302) may further include operating the fan and a fan pressure ratio of less than about 1.5 or lower. Notably, operating the fan and a fan pressure ratio of less than about two at (302) may correspond to an operating condition in which a relatively low amount of thrust is desired from the fan. For example, in certain exemplary aspects, operating the fan at the fan pressure ratio of less than about two may include operating the fan during a taxiing operating mode of the gas turbine engine and/or of an aircraft to which the gas turbine engine is attached.

Referring still to FIG. 11, the exemplary method (300) additionally includes at (304) moving the thrust reverser assembly from the fully stowed position to a partially deployed position. The partially deployed position is located between the fully stowed position and the fully deployed position. Notably, moving the thrust reverser to the partially deployed position at (304) may include moving a transcowl of the thrust reverser assembly aftwardly from a fan cowl of the nacelle assembly to define an opening therebetween, and may also include maintaining a cascade segment of the thrust reverser system at a location substantially outside of the bypass passage of the gas turbine engine.

The exemplary method (300) may also include at (306) holding the thrust reverser system in the partially deployed position to allow an additional amount of airflow to exit the bypass passage. Notably, holding the thrust reverser in the partially deployed position may allow for at least about fifteen percent of an airflow through the bypass passage to exit through the opening defined between the transcowl and the fan cowl.

Furthermore, the exemplary method (300) depicted includes at (308) moving the thrust reverser assembly from the partially deployed position to the fully stowed position, and at (310) locking the thrust reverser assembly in the fully stowed position. For example, the exemplary method (300) may move the thrust reverser system to the fully stowed position at (308) and may lock the thrust reverser system in the fully stowed position at (310) after a taxiing operating mode and prior to a takeoff operating mode of the gas turbine engine, or an aircraft to which the gas turbine engine is attached. Locking the thrust reverser assembly in the fully stowed position at (310) may ensure the thrust reverser assembly is not inadvertently moved to a partially deployed position or fully deployed position during flight.

Referring still to FIG. 11, the exemplary method (300) additionally includes at (312) confirming the thrust reverser assembly is locked in the fully stowed position by initiating an operation to move the thrust reverser assembly from the fully stowed position. In certain exemplary aspects, a locking assembly for locking the thrust reverser system in the fully stowed position at (310) may be provided and operated independently of the thrust reverser system. Additionally, confirming the thrust reverser assembly is locked in the fully stowed position at (312) may also take place prior to a flight operating mode of, e.g., the gas turbine engine or an aircraft to which the gas turbine engine is attached.

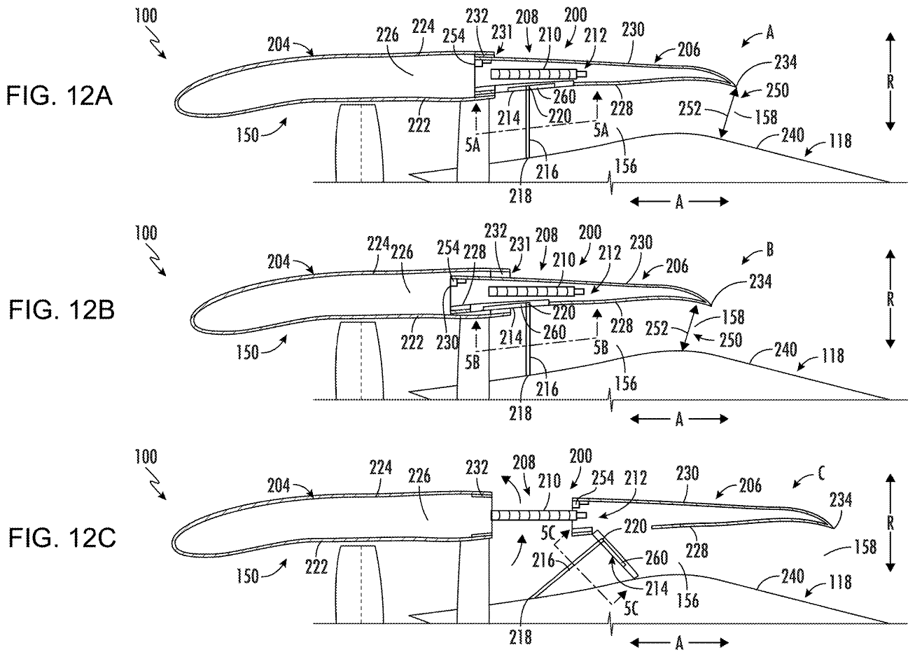

Referring now to FIGS. 12A-12C, a thrust reverser assembly 400 in accordance with another exemplary embodiment of the present disclosure is provided. In particular, FIGS. 12A-12C depict different positions or actuation states of the thrust reverser assembly 400 according to the present disclosure. In exemplary embodiments, the thrust reverser assembly 400 may be selectively positioned, or translated forward or aft, during different flight phases of an aircraft to adjust an area of the fan exit nozzle 76 for such flight phases. In FIG. 12A, the thrust reverser assembly 400 is depicted in a position A corresponding generally to a high-power flight phase such as, by way of non-limiting example, a takeoff flight phase or a top-of-climb flight phase of the aircraft. In FIG. 12B, the thrust reverser assembly 400 is depicted in a position B corresponding generally to a low-power flight phase such as, by way of non-limiting example, a cruise flight phase of the aircraft. In FIG. 12C, the thrust reverser assembly 400 is depicted in a position C corresponding to a deployed configuration (i.e., is deployed). In other words, FIG. 12C depicts the thrust reverser assembly 400 in a deployed state, in position C, such that a flow of bypass air within the bypass airflow passage 56 is diverted to provide a thrust reversal effect.

In exemplary embodiments, the cascade assembly 408 includes one or more cascade vanes 410 that are circumferentially spaced around a circumference of the nacelle assembly 50. The cascade vanes 410 are disposed between or at the juncture of the fan cowl 404 and the transcowl 406 which are selectively uncovered upon axial translation of the transcowl 406 upon reaching the position C or become uncovered as the transcowl 406 moves aft from the position A to the position C. In exemplary embodiments of the present disclosure, the cascade vanes 410 remain covered in positions A and B. In exemplary embodiments, one or more actuation assemblies 412 are mounted to the nacelle assembly 50. The actuation assemblies 412 may be circumferentially spaced apart and coupled to at least one of the transcowl 406 or the thrust reverser assembly 400. The actuation assemblies 412 are configured to move or translate the transcowl 406 in an axial direction forward and aft with respect to the fan cowl 404. The actuation assemblies 412 can be of any suitable type such as, by way of non-limiting example, rails, gliding elements, carriages, threaded rods, linkages or link assemblies, ball-screw or screw jack actuators, rotary actuators, etc., and can be driven by, e.g., pneumatic, hydraulic, or electric motors.

The thrust reverser assembly 400 also includes one or more blocker doors 414 pivotally mounted to the transcowl 406 that border the bypass airflow passage 56 when stowed. The blocker doors 414 are selectively deployed when the transcowl 406 is translated aft to the position C as depicted in FIG. 12C. In exemplary embodiments, one or more drag links 416 are operatively coupled to the blocker doors 414 for moving the blocker doors 414 between a stowed position (positions A and B) and a deployed position (position C). In the exemplary embodiments, a radially inward end 418 of the drag link 416 is pivotally coupled to the outer casing 18, and a radially outward end 420 of the drag link 416 is pivotally coupled to an intermediate portion of a respective blocker door 414. The blocker doors 414 are also pivotally coupled to the transcowl 406 at or near a forward or upstream end of the transcowl 406 so that the blocker doors 414 may pivot into the bypass airflow passage 56 (i.e., deployed) as the transcowl 406 translates in the aft direction from the position B to the position C.

Referring to FIGS. 12A and 12B, the fan cowl 404 includes an inner wall 422, and an outer wall 424 disposed radially outward and spaced apart from the inner wall 422. The inner wall 422 and the outer wall 424 define an interior area 426 of the fan cowl. The transcowl 406 also includes an inner wall 428, and an outer wall outer 430 disposed radially outward and spaced apart from the inner wall 428. In exemplary embodiments, in at least one or more of the positions A and B, at least a portion of the transcowl 406 is positioned within the fan cowl 404 or at least partially within the interior area 426 of the fan cowl 404. In other words, in at least one or more of the positions A and B, at least a portion of the outer wall 424 of the fan cowl 404 is disposed radially outward from and overlaps at least a portion of the outer wall 430 of the transcowl 406, and at least a portion of the inner wall 422 of the fan cowl 404 is disposed radially inward from and overlaps at least a portion of the inner wall 428 of the transcowl 406. In the illustrated embodiment, the overlapped position of the outer wall 424 with respect to the outer wall 430 causes an aft-facing step 431 at the radially outward interface of the fan cowl 404 with the transcowl 406, and the overlapped position of the inner wall 422 with respect to the inner wall 428 causes an aft-facing step 433 at the radially inward interface of the fan cowl 404 with the transcowl 406 within the bypass airflow passage 56. In exemplary embodiments, in at least one or more of the positions A and B, at least a portion of the transcowl 406 is positioned within the fan cowl 404 or at least partially within the interior area 426 of the fan cowl 404 such that the steps 431 and 433 are aft-facing to avoid airflow separation in at least the bypass airflow passage 56. In exemplary embodiments, one or more seals 432 may be disposed between the fan cowl 404 and the transcowl 406 in the overlapping portion or at another suitable interface of the fan cowl 404 and the transcowl 406 to seal against undesirable airflow leakage radially outwardly from the bypass airflow passage 56 such as, by way of non-limiting example, when the transcowl 406 is located in at least one or more of the positions A and B. The seal 432 may be any conventional seal or sealing mechanism such as, by way of non-limiting example, a compressible sealing material, seals as used in bleed air applications, seals as used in ducting applications, or various types of thrust reverser door seals.

As described above, the bypass airflow passage 56 is configured to provide a converging flow area which terminates near a trailing edge 434 of the transcowl 406 corresponding to the fan exit nozzle 76. As depicted in FIGS. 12A-12C, the outer casing 18 has a contoured portion 440 that slopes radially inward as the outer casing 18 extends aft in the axial direction such that the outer casing 18 and the transcowl 406 define the fan exit nozzle 76. As depicted in FIGS. 12A and 12B, axial translation of the transcowl 406 between the positions A and B, respectively, varies a throat area 450 of the fan exit nozzle 76. The throat area 450 may be defined as a minimum flow area defined by the fan exit nozzle 76 measured along a line 452 extending perpendicular to and radially outward from contoured portion 440 of the outer casing 18. Thus, axial movement or translation of the transcowl 406 also causes the axial movement or translation of the trailing edge 434 of the transcowl 406 with respect to the outer casing 18 and the contoured portion 440. Accordingly, the variable positioning of the trailing edge 434 of the transcowl 406 with respect to the contoured portion 440 causes a change in a length of the line 452 and, correspondingly, a size of the throat area 450. In exemplary embodiments, for the gas turbine engine 100 depicted in FIGS. 12A and 12B configured as a short duct separate flow exhaust system, the throat area 450 at the position A (FIG. 12A) is greater than the throat area 450 at the position B (FIG. 12B).

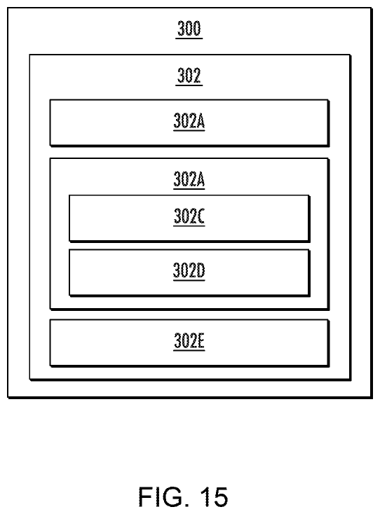

In exemplary embodiments, a sensor 454 may be used to sense or detect the axial position of the transcowl 406. The sensor 454 may be communicatively coupled to a controller. The actuation assembly 412 may be automatically controlled, such as by the controller, based on information communicated by the sensor 454. Thus, the controller may be used to vary the throat area 450 of the fan exit nozzle 76 based on the sensed or detected position of the transcowl 406. The controller may be configured similar to exemplary computing devices of the computing system 500 described below with reference to FIG. 15. In certain embodiments, the controller may be a full authority digital engine control controller (a FADEC).

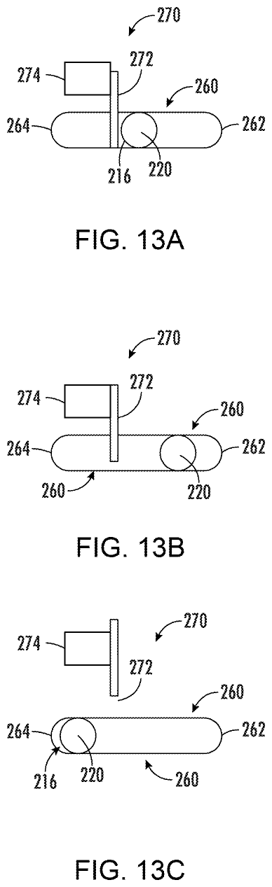

In exemplary embodiments, the ends 420 of the drag links 416 are pivotally coupled to the respective blocker doors 414 via one or more slot joints 460. The one or more slot joints 460 extend axially (when the blocker doors 414 are in a stowed position, such as in positions A and B) such that the transcowl 406 is movable forward and aft without deploying the blocker doors 414. In other words, the ends 420 of the drag links 416 are axially movable within the slot joints 460 resulting from axial movement of the transcowl 406. FIGS. 13A-13C depict the position of the end 420 of the drag link 416 within the slot joint 460 corresponding to respective positions A-C of respective FIGS. 12A-12C. As depicted in FIG. 13A, in the position A, the end 420 of the drag link 416 is medially positioned within the slot joint 460. In FIG. 13B, the transcowl 406 has been translated axially forward (FIG. 12B) such that the end 420 of the drag link 416 is positioned at or near an aft end 462 of the slot joint 460. In FIG. 13C, the transcowl 406 has been translated axially aft (FIG. 12C) such that the end 420 of the drag link 416 has reached a forward end 464 of the slot joint 460 such that the end 420 is prevented or restrained from further axial movement within the slot joint 460. Accordingly, when the end 420 reaches forward end 464 of the slot joint 460, further axial rearward movement of the transcowl 406 causes the blocker doors 414 (FIG. 12C) to be pivoted radially inward into a deployed position as depicted in the position C (FIG. 12C).

In exemplary embodiments, one or more stop mechanisms 470 may be included and configured to prevent movement of the transcowl 406 to the position C in flight (FIGS. 12C and 13C) without sensing the aircraft has landed by use of a sensor such as, by way of non-limiting example, a weight on wheels indication or, in other words, to prevent deployment of the blocker doors 414 (FIGS. 12A-12C) in a flight phase of the aircraft. In exemplary embodiments, the one or more stop mechanisms 470 may include a hydraulically or electromechanically actuatable mechanism that limits aft movement of the transcowl 406 (FIGS. 12A-12C) until a weight on wheels sensor (not shown) is engaged due to the aircraft being on the ground. In exemplary embodiments, the one or more stop mechanisms 470 may include a pin, track stop, motor limit stop, or other type of mechanism configured to limit aft movement of the transcowl 406.

In FIGS. 13A-13C, the one or more stop mechanisms 470 include one or more pins 472 coupled to or movably positionable with respect to the one or more slot joints 460. The one or more pins 472 may be coupled to one or more actuators 474 that are actuatable to cause movement of the one or more pins 472 with respect to the one or more respective slot joints 460. The one or more actuators 474 may be part of the actuation assembly 412 or may be independent or stand-alone actuators. In exemplary embodiments, at least a portion of the one or more pins 472 may reside within at least a portion of the slot joint 460, such as depicted in FIGS. 13A and 13B, to prevent axial travel of the end 420 of the drag link 416 to the forward end 464 of the slot joint 460. In FIGS. 13A and 13B, the pin 472 may be considered in an actuated position such that the pin 472 prevents axial travel of the end 420 of the drag link 416 to the forward end 464 of the slot joint 460. In response to a weight on wheel indication, the actuators 474 may be actuated to move or withdraw the one or more pins 472 from the slot joint 460, as depicted in FIG. 13C, to enable movement of the end 420 of the drag link 416 to the forward end 464 of the slot joint 460 to deploy the blocker doors 414 (FIGS. 12A-12C).

Thus, in FIG. 13C, the pin 472 is in a de-actuated position with respect to the slot joint 460. Accordingly, the one or more stop mechanisms 470 may be actuated or de-actuated to respectively prevent or enable axial translation of the transcowl 406 into the deploy position of the thrust reverser assembly 400 as depicted in position C (FIG. 12C). It should be understood that the one or more stop mechanisms 470 may also be part of or formed as part of the actuation assembly 412 (FIGS. 12A-12C) such that the actuation assembly 412 (FIGS. 12A-12C) is configured to limit axial aft travel of the transcowl 406 to the position C to deploy the blocker doors 414 (FIGS. 12A-12C) without a weight on wheel indication. The actuation assembly 412 (FIGS. 12A-12C), the actuator 474 (FIGS. 13A-13B), or both, may be automatically controlled, such as by the controller. It should also be understood that other types of mechanisms or linkage assemblies may be used to enable in-flight forward and aft movement of the transcowl 406 (FIGS. 12A-12C) such as, by way of non-limiting example, a slider mechanism on the drag links 416 (FIGS. 12A-12C) to effectively create a slider crank mechanism.

In exemplary embodiments, the controller may be configured to control the throat area 450 of the fan exit nozzle 76 (FIGS. 12A and 12B) via the actuation assembly 412 (FIGS. 12A-12C) to correspondingly control a maximum or minimum fan pressure ratio (FPR) variation as a function of an operating condition of the gas turbine engine 10 (FIG. 5). The FPR is a ratio between a first volume of air passing through the bypass airflow passage 56 (FIG. 5) and a second volume of air passing through the core air flowpath 37 (FIG. 5). By controlling the axial movement of the transcowl 406 (FIGS. 12A and 12B) between the respective positions A and B (FIGS. 12A and 12B) and, correspondingly, the throat area 450 of the fan exit nozzle 76 (FIGS. 12A and 12B), variations in the FPR can be controlled during different flight phases of the aircraft. In exemplary embodiments, the controller may be configured to control the throat area 450 of the fan exit nozzle 76 (FIGS. 12A and 12B) via the actuation assembly 412 (FIGS. 12A-12C) based on a percentage of a maximum thrust of the gas turbine engine 10 (FIG. 5). For example, in exemplary embodiments, a ratio of the percentage of maximum thrust of the gas turbine engine 10 (FIG. 5) with respect to the rotational speed of the LP spool 36 (FIG. 5) may be used to define or control the throat area 450 of the fan exit nozzle 76 (FIGS. 12A and 12B) via the actuation assembly 412 (FIGS. 12A-12C). It should also be understood that the controller may be configured to automatically control the throat area 450 of the fan exit nozzle 76 (FIGS. 12A and 12B) via the actuation assembly 412 (FIGS. 12A-12C) based on other detected parameters of the gas turbine engine 10 (FIG. 5), based on different flight phases of the aircraft, and/or based on user instructions, such as from a pilot of the aircraft.

In exemplary embodiments, in response to detecting a failure indication corresponding to the thrust reverser assembly 400 (FIGS. 12A-12C), the actuation assembly 412 is configured to move the transcowl 406 to the position A depicted in FIG. 12A. For example, in exemplary embodiments, in response to detecting a failure indication corresponding to the thrust reverser assembly 400 (FIGS. 12A-12C), the controller may actuate the actuation assembly 412 to translate the transcowl 406 to the position A depicted in FIG. 12A to obtain a largest possible throat area 450 of the fan exit nozzle 76 as depicted in FIG. 12A.

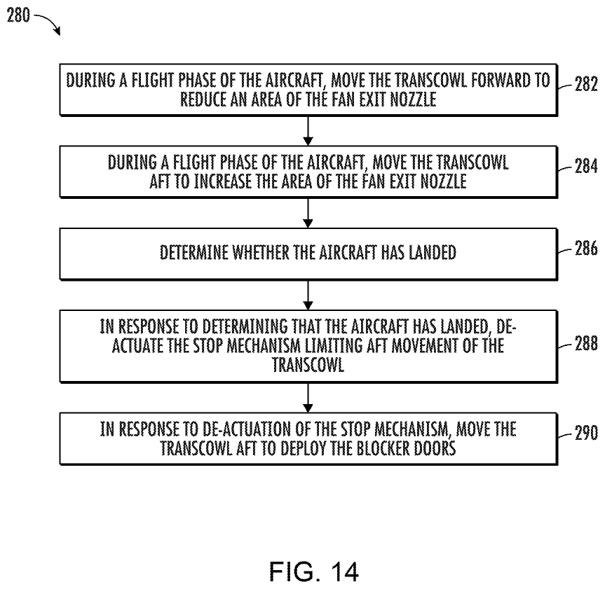

FIG. 14 provides a flow diagram of an exemplary method (480) for varying a size of the throat area 450 of the fan exit nozzle 76 in accordance with exemplary embodiments of the present disclosure. It should be appreciated that the method (480) is discussed herein only to describe exemplary aspects of the present subject matter and is not intended to be limiting.

At (482), the method (480) includes, during a flight phase of the aircraft, moving the transcowl 406 forward to reduce an area of the fan exit nozzle 76. As described above, movement of the transcowl 406 forward may be automatically controlled such as, by way of non-limiting example, by the controller based on a percentage of a maximum thrust of the gas turbine engine 100, based on a particular phase of a flight condition of the aircraft, or by pilot control. At (484), the method (480) includes, during a flight phase of the aircraft, moving the transcowl 406 aft to increase an area of the fan exit nozzle 76. Similarly, movement of the transcowl 406 aft may be automatically controlled such as, by way of non-limiting example, by the controller based on a percentage of a maximum thrust of the gas turbine engine 100, based on a particular phase of a flight condition of the aircraft, or by pilot control. At (486), the method (480) includes determining whether the aircraft has landed such as, by way of non-limiting example, detecting a weight on wheels indication, such as by the controller. At (488), the method (480) includes, responsive to detecting that the aircraft has landed, de-actuating the stop mechanism 470 restricting or limiting aft travel of the transcowl 406. De-actuation of the stop mechanism 470 may also be automatically controlled such as, by way of non-limiting example, by the controller in response to detecting that the aircraft has landed. At (490), the method (480) includes, responsive to de-actuating the stop mechanism 470, moving the transcowl 406 aft to deploy the blocker doors 414. The aft movement of the transcowl 406 to deploy the blocker doors 414 may also be automatically controlled, such as by the controller.

FIG. 15 provides an example computing system 500 according to example embodiments of the present disclosure. The computing devices or elements described herein, such as the controller, may include various components and perform various functions of the computing system 500 described below, for example.

As shown in FIG. 15, the computing system 500 can include one or more computing device(s) 502. The computing device(s) 502 can include one or more processor(s) 502A and one or more memory device(s) 502B. The one or more processor(s) 502A can include any suitable processing device, such as a microprocessor, microcontroller, integrated circuit, logic device, and/or other suitable processing device. The one or more memory device(s) 502B can include one or more computer-executable or computer-readable media, including, but not limited to, non-transitory computer-readable media, RAM, ROM, hard drives, flash drives, and/or other memory devices.

The one or more memory device(s) 502B can store information accessible by the one or more processor(s) 502A, including computer-readable instructions 502C that can be executed by the one or more processor(s) 502A. The computer-readable instructions 502C can be any set of instructions that when executed by the one or more processor(s) 502A, cause the one or more processor(s) 502A to perform operations. In some embodiments, the computer-readable instructions 502C can be executed by the one or more processor(s) 502A to cause the one or more processor(s) 502A to perform operations, such as any of the operations and functions for which the computing system 500 and/or the computing device(s) 502 are configured, such as controlling operation of actuation assembly 412, the actuators 474, or both. The computer-readable instructions 502C can be software written in any suitable programming language or can be implemented in hardware. Additionally, and/or alternatively, the computer-readable instructions 502C can be executed in logically and/or virtually separate threads on processor(s) 502A. The memory device(s) 502B can further store data 502D that can be accessed by the processor(s) 502A. For example, the data 502D can include models, lookup tables, databases, etc.

The computing device(s) 502 can also include a network interface 502E used to communicate, for example, with the other components of the computing system 500 (e.g., via a communication network). The network interface 502E can include any suitable components for interfacing with one or more network(s), including for example, transmitters, receivers, ports, controllers, antennas, and/or other suitable components. One or more devices can be configured to receive one or more commands from the computing device(s) 502 or provide one or more commands to the computing device(s) 502.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Thus, embodiments of the present disclosure provide a thrust reverser assembly that is actuable to vary an area of a fan exit nozzle of the gas turbine engine during a flight phase of an aircraft. In particular, the transcowl of a gas turbine engine is movable forward and aft during flight phases of the aircraft to vary the area of the fan exit nozzle of a gas turbine engine. In exemplary embodiments, the transcowl may be translated forward or aft during a flight phase of the aircraft without being deployed, or without deploying blocker doors into the bypass airflow passage of the gas turbine engine. In other words, during a forward phase of flight of the aircraft, no reverse thrust is generated by the thrust reverser assembly of the present disclosure. The forward movement of the thrust reverser assembly, and therefore the transcowl, reduces the fan nozzle exit area. Embodiments of the present disclosure enables a lower fan pressure ratio (FPR) at cruise flight phase conditions when the thrust reverser assembly remains closed down or undeployed, and enables a higher FPR when more thrust is required to facilitate a lower fan diameter size. Embodiments of the present disclosure also include one or more stop mechanisms to restrict aft movement of the transcowl to a thrust reverser deployed state during a flight phase of the aircraft.

Further aspects are provided by the subject matter of the following clauses:

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{Fan \_ LE} \times {R}_{Hub \_ TE}}{{R}_{Fan \_ TE} \times {R}_{Hub \_ LE}} .$$

The gas turbine engine of any preceding clause, wherein the FLTCF is greater than or equal to 1.07 and less than or equal to 1.65.

The gas turbine engine of any preceding clause, wherein the bypass ratio is greater than or equal to 13 and less than or equal to 25.

The gas turbine engine of any preceding clause, wherein the turbomachine comprises a compressor section having a low pressure compressor and a high pressure compressor, wherein the low pressure compressor is rotatable with the drive turbine.

The gas turbine engine of any preceding clause, further comprising: an outer nacelle surrounding at least in part the fan.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, and wherein the fan defines a fan blade count greater than or equal to 5 and less than or equal to 15.

The gas turbine engine of any preceding clause, wherein the FLTCF is greater than or equal to 1.07 and less than or equal to 1.25.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

The gas turbine engine of any preceding clause, wherein the FLTCF is greater than or equal to 1.12 and less than or equal to 1.35.

The gas turbine engine of any preceding clause, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{Fan \_ LE} - {R}_{Hub \_ LE}}{{R}_{Fan \_ TE} - {R}_{Hub \_ TE}} .$$

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 100; and a reduction gearbox mechanically coupling the drive turbine of the turbomachine to the fan; wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{Fan \_ LE} - {R}_{Hub \_ LE}}{{R}_{Fan \_ TE} - {R}_{Hub \_ TE}} .$$

The gas turbine engine of any preceding clause, wherein the FLTOR is greater than or equal to 1.05 and less than or equal to 1.3.

The gas turbine engine of any preceding clause, wherein the bypass ratio is greater than or equal to 13 and less than or equal to 25.

The gas turbine engine of any preceding clause, further comprising: an outer nacelle surrounding at least in part the fan.

The gas turbine engine of any preceding clause, wherein the fan is an unducted fan.

The gas turbine engine of any preceding clause, wherein the leading edge fan radius R_{Fan_LE} is greater than or equal to 65 inches and less than or equal to 85 inches, wherein the fan defines a fan blade count greater than or equal to 5 and less than or equal to 15, and wherein the FLTOR is greater than or equal to 1.05 and less than or equal to 1.2.

The gas turbine engine of any preceding clause, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio between 2:1 and 4:1, and wherein the FLTOR is greater than or equal to 1.07 and less than or equal to 1.18.

The gas turbine engine of any preceding clause, wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{Fan \_ LE} \times {R}_{Hub \_ TE}}{{R}_{Fan \_ TE} \times {R}_{Hub \_ LE} .}$$

The gas turbine engine of any preceding clause, wherein the fan is an unducted fan, wherein the leading edge fan radius R_{Fan_LE} is greater than or equal to 65 inches and less than or equal to 85 inches, wherein the fan defines a fan blade count greater than or equal to 5 and less than or equal to 15, wherein the reduction gearbox defines a gear ratio greater than 4 and less than 12, wherein a thrust rating for the gas turbine engine is between 20,000 pounds and 45,000 pounds, wherein the FLTCF is greater than or equal to 1.07 and less than or equal to 1.25, and wherein the FLTOR is greater than or equal to 1.03 and less than or equal to 1.12.

The gas turbine engine of any preceding clause, wherein the fan is a ducted fan, wherein the leading edge fan radius R_{Fan_LE} is greater than or equal to 35 inches and less than or equal to 50 inches, wherein the fan defines a fan blade count greater than or equal to 12 and less than or equal to 23, wherein the reduction gearbox defines a gear ratio greater than 2 and less than 4, wherein a thrust rating for the gas turbine engine is between 20,000 pounds and 45,000 pounds, wherein the FLTCF is greater than or equal to 1.12 and less than or equal to 1.35, and wherein the FLTOR is greater than or equal to 1.06 and less than or equal to 1.19.

The gas turbine engine of any preceding clause, wherein the fan is a ducted fan, wherein the leading edge fan radius R_{Fan_LE} is greater than or equal to 51 inches and less than or equal to 66 inches, wherein the fan defines a fan blade count greater than or equal to 17 and less than or equal to 23, wherein a thrust rating for the gas turbine engine is between 60,000 pounds and 118,000 pounds, wherein the FLTCF is greater than or equal to 1.27 and less than or equal to 1.5, and wherein the FLTOR is greater than or equal to 1.18 and less than or equal to 1.5.

The gas turbine engine of any preceding clause, wherein the fan is a ducted fan, wherein the leading edge fan radius R_{Fan_LE} is greater than or equal to 55 inches and less than or equal to 70 inches, wherein the fan defines a fan blade count greater than or equal to 12 and less than or equal to 22, wherein a thrust rating for the gas turbine engine is between 100,000 pounds and 150,000 pounds, wherein the FLTCF is greater than or equal to 1.46 and less than or equal to 1.65, and wherein the FLTOR is greater than or equal to 1.2 and less than or equal to 1.5.

A method for operating a gas turbine engine comprising a fan, a core in flow communication with the fan, and a nacelle assembly enclosing the fan and at least a portion of the core to define a bypass passage with the core, the nacelle assembly including a thrust reverser system moveable between a fully stowed position and a fully deployed position, the method comprising: operating the fan at a fan pressure ratio of less than about two (2); moving the thrust reverser system from the fully stowed position to a partially deployed position, the partially deployed position located between the fully stowed position and the fully deployed position; and holding the thrust reverser system in the partially deployed position to allow an additional amount of airflow to exit the bypass passage.

The method of any preceding clause, wherein the nacelle assembly includes a fan cowl enclosing the fan, wherein the thrust reverser system includes a transcowl positioned aft of the fan cowl, and wherein moving the thrust reverser to the partially deployed position includes moving the transcowl aftwardly from the fan cowl to define an opening therebetween.

The method of any preceding clause, wherein moving the thrust reverser system from the fully stowed position to the partially deployed position includes moving the transcowl aftwardly at least about five inches.

The method of any preceding clause, wherein the fan defines a fan diameter, and wherein moving the thrust reverser system from the fully stowed position to the partially deployed position includes moving the transcowl aftwardly a distance equal to at least about 2% of the fan diameter.

The method of any preceding clause, wherein holding the thrust reverser in the partially deployed position includes allowing at least about fifteen percent (15%) of an airflow through the bypass passage to exit through the opening defined between the transcowl and the fan cowl.

The method of any preceding clause, wherein moving the thrust reverser to the partially deployed position includes maintaining a cascade segment of the thrust reverser at a location substantially outside of the bypass passage.

The method of any preceding clause, wherein the gas turbine engine is a turbofan engine, and wherein the fan is a fixed-pitch fan.

The method of any preceding clause, wherein operating the fan at the fan pressure ratio of less than about two (2) includes operating the fan at a fan pressure ratio of less than about 1.5.

The method of any preceding clause, wherein operating the fan at the fan pressure ratio of less than about two (2) includes operating the fan during a taxiing operating mode.

The method of any preceding clause, further comprising moving the thrust reverser system from the partially deployed position to the fully stowed position; and locking the thrust reverser system in the fully stowed position.

The method of any preceding clause, further comprising confirming the thrust reverser system is locked in the fully stowed position by initiating an operation to move the thrust reverser system from the fully stowed position.

A gas turbine engine comprising: a fan defining a fan pressure ratio during operation; a core in flow communication with the fan; and a nacelle assembly enclosing the fan and at least a portion of the core to define a bypass passage with the core, the nacelle assembly comprising a fan cowl extending around the fan; and a thrust reverser system moveable between a fully stowed position, a partially deployed position, and a fully deployed position, the thrust reverser system configured to be held in the partially deployed position to allow an additional amount of airflow to exit from the bypass passage.

The gas turbine engine of any preceding clause, wherein the nacelle assembly further includes a fan cowl enclosing the fan, wherein the thrust reverser system includes a transcowl positioned aft of the fan cowl, and wherein moving the thrust reverser system from the fully stowed position to a partially deployed position includes moving the transcowl aftwardly from the fan cowl such that the nacelle assembly defines an opening between the fan cowl and the transcowl when the thrust reverser system is in the partially deployed position.

The gas turbine engine of any preceding clause, wherein the opening defined between the fan cowl and the transcowl when the thrust reverser system is in the partially deployed position is at least about five inches long along an axial direction of the gas turbine engine.

The gas turbine engine of any preceding clause, wherein the opening defined between the fan cowl and the transcowl when the thrust reverser system is in the partially deployed position allows for at least about fifteen percent (15%) of an airflow through the bypass passage to exit therethrough during operation.

The gas turbine engine of any preceding clause, wherein a cascade segment of the thrust reverser system remains at a location substantially outside of the bypass passage when the thrust reverser system is in the partially deployed position.

The gas turbine engine of any preceding clause, wherein the fan is a fixed-pitch fan.

The gas turbine engine of any preceding clause, wherein the thrust reverser is configured to be held in the partially deployed position when the fan defines a fan pressure ratio of less than about two (2).

The gas turbine engine of any preceding clause, wherein the thrust reverser is configured to be held in the partially deployed position when the gas turbine engine is operated in a taxiing operating mode.

The gas turbine engine of any preceding clause, wherein the nacelle assembly further includes a locking mechanism configured to lock the thrust reverser system in the fully stowed position.

A gas turbine engine for an aircraft, the gas turbine engine comprising: a core cowl; a nacelle assembly positioned radially outward of the core cowl defining a bypass airflow passage between the core cowl and the nacelle assembly, the bypass airflow passage having a fan exit nozzle, the nacelle assembly comprising: a fan cowl; a transcowl positioned aft of the fan cowl; and a thrust reverser assembly having a cascade assembly; and an actuation assembly operably connected to at least one of the transcowl or the thrust reverser assembly, wherein the actuation assembly is actuatable to move the transcowl aft from a first position where the cascade assembly is covered to a second position where the cascade assembly is uncovered, the actuation assembly further actuatable to move the transcowl forward from the first position to a third position to reduce an area of the fan exit nozzle.

The gas turbine engine of the preceding clause, wherein at least a portion of the transcowl is positioned within the fan cowl when the transcowl is in the third position.

The gas turbine engine of any preceding clause, wherein the thrust reverser assembly comprises: one or more blocker doors deployable into the bypass airflow passage when the transcowl is moved from the first position to the second position; and one or more drag links pivotally coupled to the one or more blocker doors via one or more slot joints.

The gas turbine engine of any preceding clause, further comprising at least one stop mechanism configured to prevent movement of the transcowl to the second position without a weight on wheels indication.

The gas turbine engine of any preceding clause, wherein the at least one stop mechanism is coupled to the actuation assembly.

The gas turbine engine of any preceding clause, wherein the thrust reverser assembly comprises: one or more blocker doors deployable into the bypass airflow passage when the transcowl is moved from the first position to the second position; and one or more drag links pivotally coupled to the one or more blocker doors via one or more slot joints; and wherein the at least one stop mechanism is coupled to the one or more slot joints.

The gas turbine engine of any preceding clause, wherein the cascade assembly is covered when the transcowl is in the third position.

The gas turbine engine of any preceding clause, wherein the actuation assembly is actuatable to move the transcowl aft from the third position to the first position during at least one of a top of climb flight phase or a cruise flight phase of the aircraft.

The gas turbine engine of any preceding clause, wherein the actuation assembly is actuatable to move the transcowl forward from the first position to the third position during at least one of a top of climb flight phase or a cruise flight phase of the aircraft.

The gas turbine engine of any preceding clause, wherein, in response to detecting a failure indication corresponding to the thrust reverser assembly, the actuation assembly is configured to move the transcowl from the third position to the first position.

The gas turbine engine of any preceding clause, further comprising a controller configured to automatically control the actuation assembly.

The gas turbine engine of any preceding clause, wherein the at least one stop mechanism includes at least one pin movably positionable with respect to the slot joint.

The gas turbine engine of any preceding clause, wherein at least a portion of the fan cowl overlaps at least a portion of the transcowl in at least one of the first position or the third position.

The gas turbine engine of any preceding clause, wherein a position of the fan cowl with respect to the transcowl in at least one of the first position or the third position forms at least one aft facing step at an interface of the fan cowl with the transcowl.

The gas turbine engine of any preceding clause, wherein the at least one aft facing step is located at one or more of a radially inward interface of the fan cowl with the transcowl or a radially outward interface of the fan cowl with the transcowl.

The gas turbine engine of any preceding clause, wherein the radially inward interface is within the bypass airflow passage.

The gas turbine engine of any preceding clause, further comprising one or more seals disposed at an interface of the fan cowl with the transcowl.

The gas turbine engine of any preceding clause, wherein at least one seal of the one or more seals is disposed between an overlapping portion of the fan cowl with respect to the transcowl.

A gas turbine engine for an aircraft, the gas turbine engine comprising: a core cowl; a nacelle assembly positioned radially outward of the core cowl defining a bypass airflow passage between the core cowl and the nacelle assembly, the nacelle assembly comprising: a fan cowl; a transcowl positioned aft of the fan cowl; and a thrust reverser assembly deployable into the bypass airflow passage in response to aft movement of the transcowl with respect to the fan cowl; and an actuation assembly operably connected to the transcowl, wherein the actuation assembly is actuatable to move the transcowl forward during a cruise flight phase of the aircraft.

The gas turbine engine of any preceding clause, wherein the bypass airflow passage has a fan exit nozzle defined between the core cowl and the nacelle assembly, and wherein the actuation assembly is actuatable to move the transcowl forward during the cruise flight phase to reduce an area of the fan exit nozzle.

The gas turbine engine of any preceding clause, wherein the thrust reverser assembly includes a cascade assembly, and wherein the cascade assembly is covered when the transcowl is moved forward during the cruise flight phase.

The gas turbine engine of any preceding clause, wherein at least a portion of the transcowl is positioned within the fan cowl when the transcowl is moved forward.

The gas turbine engine of any preceding clause, wherein the thrust reverser assembly comprises: one or more blocker doors deployable into the bypass airflow passage; and one or more drag links pivotally coupled to the one or more blocker doors via one or more slot joints.

The gas turbine engine of any preceding clause, further comprising at least one stop mechanism configured to prevent movement of the transcowl aft to deploy the thrust reverser assembly without a weight on wheels indication.

A method for operating a gas turbine engine for an aircraft, the gas turbine engine including a core cowl and a nacelle assembly positioned radially outward of the core cowl defining a bypass airflow passage having a fan exit nozzle between the core cowl and the nacelle assembly, wherein the nacelle assembly includes a fan cowl, a transcowl, and a thrust reverser assembly deployable into the bypass airflow passage in response to aft movement of the transcowl, the method comprising: operating the gas turbine engine in a cruise flight phase of the aircraft; and while the aircraft is in the cruise flight phase, moving, via a controller, the transcowl forward to reduce an area of the fan exit nozzle.

The method of any preceding clause, wherein moving the transcowl forward comprises positioning at least a portion of the transcowl within the fan cowl.

The method of any preceding clause, further comprising at least one stop mechanism configured to prevent movement of the transcowl to deploy the thrust reverser assembly while the aircraft is in the cruise flight phase, the method further comprising: de-actuating, via the controller, the stop mechanism in response to detecting a weight on wheels indication.

The method of any preceding clause, wherein the thrust reverser assembly comprises: one or more blocker doors deployable into the bypass airflow passage; and one or more drag links pivotally coupled to the one or more blocker doors via one or more slot joints; and wherein moving the transcowl forward comprises moving the transcowl along the one or more slot joints

A gas turbine engine defining a radial direction and an axial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 30; and a reduction gearbox mechanically coupling the drive turbine of the turbomachine to the fan; wherein the gas turbine engine defines a Fan Leading Edge to Trailing Edge Compression Factor (FLTCF) greater than or equal to 1.05 and less than or equal to 1.8, the FLTCF being equal to:

$$\frac{{R}_{{Fan}_{LE}} \times {R}_{{Hub}_{TE}}}{{R}_{{Fan}_{TE}} \times {R}_{{Hub}_{LE}}} ,$$

a nacelle assembly enclosing at least a portion of the fan and the turbomachine and defining a fan exit nozzle, the nacelle assembly including a translating cowl movable in the axial direction; and an actuation system operably connected to the translating cowl and configured to move the translating cowl between at least a first flight position and a second flight position during a flight phase to vary a throat area of the fan exit nozzle.

The gas turbine engine of any preceding clause, wherein the nacelle assembly defines in part a bypass passage, wherein the actuation system is further configured to move the translating cowl to a partially deployed position during a ground operation phase to define an auxiliary airflow exit from the bypass passage.

The gas turbine engine of any preceding clause, wherein the ground operation is a taxiing operating mode, and wherein the fan defines a fan pressure ratio of less than 1.5 during the taxiing operating mode.

The gas turbine engine of any preceding clause, wherein the auxiliary airflow exit is an annular opening defined between an aft end of a fan cowl and a forward end of the translating cowl, the annular opening having an axial length of at least three inches.

The gas turbine engine of any preceding clause, wherein the nacelle assembly defines in part a bypass passage, wherein the nacelle assembly comprises a thrust reverser system having a cascade segment, wherein when the translating cowl is in the partially deployed position, the cascade segment of the thrust reverser system remains substantially outside of the bypass passage.

The gas turbine engine of any preceding clause, wherein the nacelle assembly includes a fan cowl, wherein in the first flight position, at least a portion of the translating cowl is positioned within an interior area of the fan cowl, such that an outer wall of the fan cowl overlaps an outer wall of the translating cowl to define an aft-facing step at a radially outward interface.

The gas turbine engine of any preceding clause, further comprising a blocker door and a drag link, wherein the drag link is pivotally coupled to the blocker door via a slot joint, the slot joint configured to permit axial movement of the translating cowl between the first flight position and the second flight position without deploying the blocker door.

The gas turbine engine of any preceding clause, further comprising a stop mechanism configured to prevent axial movement of the translating cowl that would deploy the blocker door during the flight phase.

The gas turbine engine of any preceding clause, wherein the stop mechanism includes a pin movable by an actuator, the pin being positionable to block a path of the drag link within the slot joint.

The gas turbine engine of any preceding clause, wherein the first flight position corresponds to a cruise flight phase and provides a reduced throat area of the fan exit nozzle, and wherein the second flight position corresponds to a takeoff flight phase and provides an increased throat area of the fan exit nozzle.

The gas turbine engine of any preceding clause, wherein the FLTCF is greater than or equal to 1.07 and less than or equal to 1.65.

The gas turbine engine of any preceding clause, wherein the bypass ratio is greater than or equal to 13 and less than or equal to 25.

The gas turbine engine of any preceding clause, wherein the turbomachine comprises a compressor section having a low pressure compressor and a high pressure compressor, wherein the low pressure compressor is rotatable with the drive turbine.

The gas turbine engine of any preceding clause, wherein the leading edge fan radius RFan_LE is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

The gas turbine engine of any preceding clause, wherein the FLTCF is greater than or equal to 1.12 and less than or equal to 1.35.

The gas turbine engine of any preceding clause, wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} .$$

A gas turbine engine defining a radial direction, the gas turbine engine comprising: a turbomachine comprising a drive turbine and defining a working gas flowpath and an inlet to the working gas flowpath; a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 30; and a reduction gearbox mechanically coupling the drive turbine of the turbomachine to the fan; wherein the gas turbine engine defines a Fan Leading Edge to Trailing Edge Opening Ratio (FLTOR) greater than or equal to 1.03 and less than or equal to 1.5, the FLTOR being equal to:

$$\frac{{R}_{{Fan}_{LE}} - {R}_{{Hub}_{LE}}}{{R}_{{Fan}_{TE}} - {R}_{{Hub}_{TE}}} ,$$

a nacelle assembly enclosing at least a portion of the fan and the turbomachine and defining a fan exit nozzle, the nacelle assembly including a translating cowl movable in the axial direction; and an actuation system operably connected to the translating cowl and configured to move the translating cowl between at least a first flight position and a second flight position during a flight phase to vary a throat area of the fan exit nozzle.

The gas turbine engine of any preceding clause, wherein the nacelle assembly defines in part a bypass passage, wherein the actuation system is further configured to move the translating cowl to a partially deployed position during a ground operation phase to define an auxiliary airflow exit from the bypass passage.

The gas turbine engine of any preceding clause, wherein the ground operation is a taxiing operating mode, and wherein the fan defines a fan pressure ratio of less than 1.5 during the taxiing operating mode.

The gas turbine engine of any preceding clause, wherein the nacelle assembly includes a fan cowl, wherein in the first flight position, at least a portion of the translating cowl is positioned within an interior area of the fan cowl, such that an outer wall of the fan cowl overlaps an outer wall of the translating cowl to define an aft-facing step at a radially outward interface.

The gas turbine engine of any of the preceding clauses, wherein the fan blades being formed of a composite material enables the fan to be designed for operation at a low fan pressure ratio to achieve high propulsive efficiency, and wherein the actuation system is configured to move the translating cowl to create the auxiliary airflow exit to improve a stability margin of the fan during operation at the low fan pressure ratio.

The gas turbine engine of any of the preceding clauses, wherein the actuation system is further configured to move the translating cowl to a partially deployed position during a ground operation phase to define an auxiliary airflow exit from a bypass passage, and wherein the auxiliary airflow exit is configured to unload fan blades of the fan to improve a stability margin of the fan.

The gas turbine engine of any of the preceding clauses, wherein a first flight position corresponds to a cruise operating condition and provides a reduced throat area of the fan exit nozzle, and wherein a second flight position corresponds to a takeoff operating condition and provides an increased throat area of the fan exit nozzle.

The gas turbine engine of any of the preceding clauses, wherein the actuation system is configured to perform a first function of varying the effective exit area of the fan nozzle during a flight phase and a second, different function of providing an auxiliary airflow path during a ground operation phase.

The gas turbine engine of any of the preceding clauses, wherein the fan is configured to operate at a fan pressure ratio of less than 1.5 during the cruise operating condition, and wherein the actuation system is configured to adjust an operating line of the fan by moving the translating cowl.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A gas turbine engine defining a radial direction and an axial direction, the gas turbine engine comprising:
a turbomachine comprising a drive turbine and defining a working gas flowpath and an inlet to the working gas flowpath;
a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 30; and
a reduction gearbox mechanically coupling the drive turbine of the turbomachine to the fan;
wherein the gas turbine engine defines a Fan Leading Edge to Trailing Edge Compression Factor (FLTCF) greater than or equal to 1.05 and less than or equal to 1.8, the FLTCF being equal to:
$$\frac{{R}_{{Fan}_{LE}} \times {R}_{{Hub}_{TE}}}{{R}_{{Fan}_{TE}} \times {R}_{{Hub}_{LE}}} ,$$
a nacelle assembly enclosing at least a portion of the fan and the turbomachine and defining a fan exit nozzle, the nacelle assembly including a translating cowl movable in the axial direction; and
an actuation system operably connected to the translating cowl and configured to move the translating cowl between at least a first flight position and a second flight position during a flight phase to vary a throat area of the fan exit nozzle.

2. The gas turbine engine of claim 1, wherein the nacelle assembly defines in part a bypass passage, wherein the actuation system is further configured to move the translating cowl to a partially deployed position during a ground operation phase to define an auxiliary airflow exit from the bypass passage.

3. The gas turbine engine of claim 2, wherein the ground operation is a taxiing operating mode, and wherein the fan defines a fan pressure ratio of less than 1.5 during the taxiing operating mode.

4. The gas turbine engine of claim 2, wherein the auxiliary airflow exit is an annular opening defined between an aft end of a fan cowl and a forward end of the translating cowl, the annular opening having an axial length of at least three inches.

5. The gas turbine engine of claim 2, wherein the nacelle assembly defines in part a bypass passage, wherein the nacelle assembly comprises a thrust reverser system having a cascade segment, wherein when the translating cowl is in the partially deployed position, the cascade segment of the thrust reverser system remains substantially outside of the bypass passage.

6. The gas turbine engine of claim 1, wherein the nacelle assembly includes a fan cowl, wherein in the first flight position, at least a portion of the translating cowl is positioned within an interior area of the fan cowl, such that an outer wall of the fan cowl overlaps an outer wall of the translating cowl to define an aft-facing step at a radially outward interface.

7. The gas turbine engine of claim 1, further comprising a blocker door and a drag link, wherein the drag link is pivotally coupled to the blocker door via a slot joint, the slot joint configured to permit axial movement of the translating cowl between the first flight position and the second flight position without deploying the blocker door.

8. The gas turbine engine of claim 7, further comprising a stop mechanism configured to prevent axial movement of the translating cowl that would deploy the blocker door during the flight phase.

9. The gas turbine engine of claim 8, wherein the stop mechanism includes a pin movable by an actuator, the pin being positionable to block a path of the drag link within the slot joint.

10. The gas turbine engine of claim 1, wherein the first flight position corresponds to a cruise flight phase and provides a reduced throat area of the fan exit nozzle, and wherein the second flight position corresponds to a takeoff flight phase and provides an increased throat area of the fan exit nozzle.

11. The gas turbine engine of claim 1, wherein the FLTCF is greater than or equal to 1.07 and less than or equal to 1.65.

12. The gas turbine engine of claim 1, wherein the bypass ratio is greater than or equal to 13 and less than or equal to 25.

13. The gas turbine engine of claim 1, wherein the turbomachine comprises a compressor section having a low pressure compressor and a high pressure compressor, wherein the low pressure compressor is rotatable with the drive turbine.

14. The gas turbine engine of claim 1, wherein the leading edge fan radius R_{Fan_LE} is greater than or equal to 35 inches and less than or equal to 50 inches, wherein the fan defines a fan blade count greater than or equal to 12 and less than or equal to 23, and wherein the reduction gearbox defines a gear ratio between 2:1 and 4:1.

15. The gas turbine engine of claim 14, wherein the FLTCF is greater than or equal to 1.12 and less than or equal to 1.35.

16. The gas turbine engine of claim 1, wherein the gas turbine engine defines a Fan Leading Edge to Trailing Edge Opening Ratio (FLTOR) greater than or equal to 1.03 and less than or equal to 1.5, the FLTOR being equal to:
$$\frac{{R}_{{Fan}_{LE}} - {R}_{{Hub}_{LE}}}{{R}_{{Fan}_{TE}} - {R}_{{Hub}_{TE}}} .$$

17. A gas turbine engine defining a radial direction, the gas turbine engine comprising:
a turbomachine comprising a drive turbine and defining a working gas flowpath and an inlet to the working gas flowpath;
a fan having a fan blade formed of a composite material, the fan blade defining a leading edge fan radius R_{Fan_LE} and a trailing edge fan radius R_{Fan_TE}, and the fan defining a leading edge hub radius R_{Hub_LE} and a trailing edge hub radius R_{Hub_TE}, the gas turbine engine defining a bypass ratio equal to a mass flowrate of an airflow from the fan over the turbomachine to a mass flowrate of an airflow from the fan through the inlet to the working gas flowpath during operation of the gas turbine engine in a cruise operating mode, the bypass ratio being greater than or equal to 10 and less than or equal to 30; and
a reduction gearbox mechanically coupling the drive turbine of the turbomachine to the fan;
wherein the gas turbine engine defines a Fan Leading Edge to Trailing Edge Opening Ratio (FLTOR) greater than or equal to 1.03 and less than or equal to 1.5, the FLTOR being equal to:
$$\frac{{R}_{{Fan}_{LE}} - {R}_{{Hub}_{LE}}}{{R}_{{Fan}_{TE}} - {R}_{{Hub}_{TE}}} ,$$
a nacelle assembly enclosing at least a portion of the fan and the turbomachine and defining a fan exit nozzle, the nacelle assembly including a translating cowl movable in the axial direction; and
an actuation system operably connected to the translating cowl and configured to move the translating cowl between at least a first flight position and a second flight position during a flight phase to vary a throat area of the fan exit nozzle.

18. The gas turbine engine of claim 17, wherein the nacelle assembly defines in part a bypass passage, wherein the actuation system is further configured to move the translating cowl to a partially deployed position during a ground operation phase to define an auxiliary airflow exit from the bypass passage.

19. The gas turbine engine of claim 18, wherein the ground operation is a taxiing operating mode, and wherein the fan defines a fan pressure ratio of less than 1.5 during the taxiing operating mode.

20. The gas turbine engine of claim 17, wherein the nacelle assembly includes a fan cowl, wherein in the first flight position, at least a portion of the translating cowl is positioned within an interior area of the fan cowl, such that an outer wall of the fan cowl overlaps an outer wall of the translating cowl to define an aft-facing step at a radially outward interface.
